(19) United States
(12) Patent Application Publication
(10) Pub. No.: US 2025/0130108 A1
(43) Pub. Date: Apr. 24, 2025

(54) POLARIMETRIC SENSOR ARRAY FOR MACHINE VISION SYSTEMS

(71) Applicants: Yimin A. WU, Waterloo (CA); Tao GUO, Waterloo (CA); Yan YONG, Zhengzhou (CN)

(72) Inventors: Yimin A. WU, Waterloo (CA); Tao GUO, Waterloo (CA); Yan YONG, Zhengzhou (CN)

(21) Appl. No.: 18/921,571

(22) Filed: Oct. 21, 2024

Related U.S. Application Data
(60) Provisional application No. 63/545,001, filed on Oct. 20, 2023.

(51) Int. Cl. G01J 4/04

(52) U.S. Cl. CPC G01J 4/04

(57) ABSTRACT

An example device includes a polarimetric sensor array comprising an optically controlled polarimetry memtransistor, the polarimetric sensor array configured to: detect incoming light representing a field of view of the polarimetric sensor array; and generate a polarization signal representing a polarization of the incoming light; and an artificial intelligence subsystem interconnected with the polarimetric sensor array, the artificial intelligence subsystem configured to: process the polarization signal for a machine vision function on the field of view.

### FIELD

The specification relates generally to machine vision systems, and more particularly to a polarimetric sensor array for machine vision systems.

### BACKGROUND

Learning from human vision have informed visible light techniques. Learnings from the vision of animals, such as bees, may inform polarimetry techniques. Combining these techniques may result in what may be termed an interspecies and/or chimeric system.

### SUMMARY

According to an aspect of the present specification an example device includes: a polarimetric sensor array comprising an optically controlled polarimetry memtransistor, the polarimetric sensor array configured to: detect incoming light representing a field of view of the polarimetric sensor array; and generate a polarization signal representing a polarization of the incoming light; and an artificial intelligence subsystem interconnected with the polarimetric sensor array, the artificial intelligence subsystem configured to: process the polarization signal for a machine vision function on the field of view.

According to another aspect of the present specification, an example method includes: detecting, at a polarimetric sensor array comprising an optically controlled polarimetry memtransistor, incoming light representing a field of view of the polarimetric sensor array; generating a polarization signal representing a polarization of the incoming light; and processing the polarization signal for a machine vision function on the field of view.

### BRIEF DESCRIPTION OF DRAWINGS

Implementations are described with reference to the following figures, in which:

FIGS. 1A and 1B depicts a schematic diagram of an example system with a polarimetric sensor array for machine vision functions.

FIG. 2 depicts a schematic diagram of a stacked ReS₂/GeSe₂ structure.

FIGS. 3A and 3B depict the atomic structures of ReS₂ and GeSe₂.

FIG. 4 depicts an optical micrograph of the stacked GeSe₂/ReS₂ layer.

FIGS. 5A and 5B depict absorption spectra of the ReS₂ layer.

FIGS. 6A and 6B depict absorption spectra of the GeSe₂ layer.

FIGS. 7A-7C depict Raman spectra and an optical micrograph of the stacked GeSe₂/ReS₂ layers for angle-resolved polarized Raman spectra.

FIGS. 8A and 8B depict experimental and fitting plots of ReS₂ and GeSe₂.

FIGS. 9A and 9B depict atomic force microscopy images of ReS₂ and GeSe₂.

FIG. 10 depicts a high-angle annular dark-field (HAADF) image of the stacked ReS₂/GeSe₂ structure and the corresponding element distribution.

FIGS. 11A and 11B depict HAADF atomic scale images of ReS₂ and GeSe₂.

FIGS. 12A and 12B depict fast Fourier transform (FFT) patterns of of ReS₂ and GeSe₂.

FIG. 13 depicts light-wavelength-dependent transfer curves.

FIGS. 14A and 14B depict conductance plots under positive photoconductivity (PPC) and negative photoconductivity (NPC).

FIG. 15 depicts the retention time of the device programmed by pulsed gate voltages.

FIG. 16 depicts potentiation and depression behaviours.

FIGS. 17A and 17B depict plots of conductance and pulse number.

FIGS. 18A-18C depict conductance modulations with different pulse numbers (PN), pulses widths (PW), and pulse power (PP).

FIGS. 19A and 19B depict endurance and retention time of the device.

FIGS. 20A and 20B depict the energy band structure and bandgap alignment of the ReS₂/GeSe₂ heterojunction.

FIG. 21 depicts density of state curves.

FIGS. 22A and 22B depict schematics of the working mechanisms of PPC and NPC.

FIG. 23 depicts the twist angle in twistronic optoelectronic devices.

FIG. 24 depicts optical microscopy image of the twistronic optoelectronic device with 60°.

FIG. 25 depicts I_{ds}-V_{gs} curves with different twist angles between ReS₂ and GeSe₂.

FIGS. 26A-F depict schematics of honeybee polarization-based navigation.

FIG. 27 depicts a schematic illustration of a polarization pattern determined by the position of the sun.

FIG. 28A depicts a schematic diagram of an experimental test setup for measuring celestial polarization patterns.

FIGS. 28B-E depict schematic diagrams of device orientations with different angles between the north and the b-axis direction of ReS2 crystal.

FIGS. 29A and 29B depict polarization-dependent I_{ds}-V_{gs} mappings.

FIGS. 30A and 30B depict experimental data points and fitting results.

FIGS. 31A and 31B depict polar coordinate plots of angle-dependent I_{ds}.

FIG. 32 depicts experimental results were compared with the theoretical values.

FIG. 33 depicts the evolution of solar azimuth angle over a day.

FIG. 34 depicts a flowchart of an example method of real-time navigation.

FIG. 35 depicts a comparison between human vision systems and OCPM-based honeybee-chimera machine vision.

FIG. 36 depicts ideal patterns, no anti-glare patterns, and anti-glare patterns.

FIGS. 37A and 37B depict schematic diagrams of artificial neural networks (ANNs).

FIGS. 38A and 38B depict dataset images for pattern recognition training and incomplete patterns.

FIG. 39 depicts patterns with and without anti-glare.

FIG. 40 depicts pattern recognition accuracies with and without OCPM-based anti-glare processing.

FIG. 41 depicts recognition accuracy plots for 9 running cycles.

FIGS. 42A and 42B depict a statistical comparison of training epochs with and without anti-glare abilities and a statistical comparison of energy consumption.

The patent or application file contains at least one drawing executed in color.

Copies of this patent or patent application publication with color drawing(s) will be provided by the Office upon request and payment of the necessary fee.

### DETAILED DESCRIPTION

Current humanoid machine vision techniques mimic human systems and lacks polarimetric functionalities that convey the information of navigation and authentic images. Interspecies-chimera vision reserving multiple hosts' capacities will lead to improved machine vision, but implementation of visual functions of multiple species (human and non-human) in one optoelectronic device is still elusive.

Traditional visual systems are bulky, energy-intensive, and lengthy, especially for cognitive tasks owing to discrete computation hierarchy. The sensory, memory, and computing units are separated from each other. The location and format (analog/digital) of image data need to be changed frequently, giving rise to the penalty of energy consumption and time delay. To solve this issue, mimicking human visual systems is a promising strategy. In human visions, photoreceptors and neurons in the human retina detect and pre-process images that are later sent to the visual cortex for cognitive signal processing. For current machine visions, intelligent photodetectors can simultaneously sense and pre-process light stimuli like a human retina. Received images are then directly transferred into artificial neural networks (ANNs) for complex visual processing. ANNs fundamentally imitate the fundamental principles of human brains relying on the activities of synapses and neurons, which can realize huge parallel computing and high-energy efficiency. However, human eyes only provide very limited photodetection abilities regarding the light wavelength (380 nm to 700 nm), intensity (comfortable intensity 200 lux to 750 lux), and vector (not sensitive to linear and circular polarity). This restrains the application of humanoid machine vision. On the other hand, interspecies-chimera machine vision integrates the cognitive function of humans and the special visual function of other species. This can provide functions beyond traditional artificial intelligence (AI) by leveraging machines to solve problems like a human while processing super-human capabilities enabled by other appealing functions.

Humanoid machine vision has been reported to reduce background noise, scotopic/photopic adaptation, broadband sensing, convolution processing, etc. In the human vision system, the image information is received and pre-processed by the retina and transferred into the visual cortex region for cognitive processing. Human vision, although, is capable of cognitive tasks. It is not sensitive to the polarization of light which includes critical information. It is rudimentary to integrate polarimetric functions into humanoid machine vision. Honeybees are known as excellent navigators with the help of ommateum measuring linearly polarized lights. The skylight pattern is determined by the position of the sun, described by the Rayleigh sky model. For instance, real-time navigation can be achieved via monitoring the sun-position-related celestial polarization cues. Indeed, the polarimetric capability makes honeybees a master for navigating from the honeycomb to a flower patch. But honeybees are not intelligent species like humans. Therefore, a rational design philosophy is to integrate the polarimetry from honeybees and the intelligence from humans, creating an interspecies-chimera machine vision. Particularly, the reflected light from shiny surfaces, including cars' windows, buildings, water on the road, and the road itself, forms glare spots. This compromises the processing accuracy in traditional machine visions due to glare-induced distortion. The formation of glare spots is because the reflected light is polarized light parallel to the surface. The polarimetric function can suppress the light intensity with a certain polarization (glare spots) and keep high fidelity in authentic images. This interspecies-chimera machine vision, on the one hand, can detect the polarization pattern in the sky for real-time navigation and on the other hand, the system can realize anti-glare pattern recognition.

As presently described, an optically-controlled polarimetry memtransistor (OCPM) based on a van der Waals heterostructure (ReS₂/GeSe₂). The device provides polarization sensitivity, nonvolatility, and positive/negative photoconductance simultaneously. The polarimetric measurement can identify celestial polarizations for real-time navigation like a honeybee. Meanwhile, cognitive tasks can be completed like a human by sensing, memory, and synaptic functions. Particularly, the anti-glare recognition with polarimetry saves an order of magnitude energy compared to the traditional humanoid counterpart. This technique promotes the concept of interspecies-chimera visual systems that may be leveraged in machine vision functions of autonomous vehicles, medical diagnoses, intelligent robotics, etc.

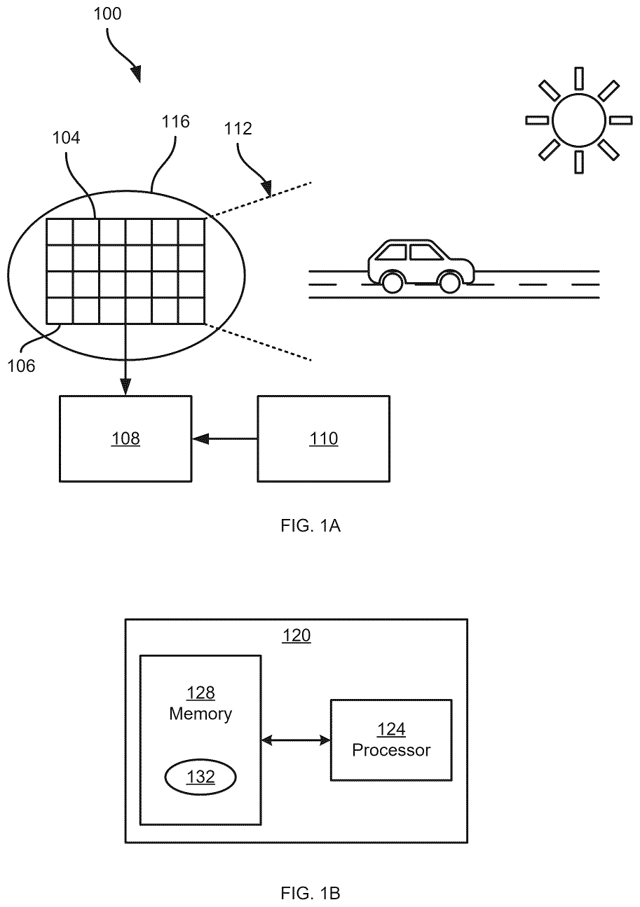

FIG. 1A depicts a system 100 for applying polarimetry for machine vision functions. The system 100 includes a polarimetric sensor array 104 and an artificial intelligence subsystem 108, which may include an artificial neural network. In some examples, the system 100 may additionally include an image sensor 110 which may capture visible light images and which may be interconnected with the polarimetric sensor array 104 and/or the artificial intelligence subsystem 108.

The system 100 may include a single device integrating the sensor array 104 and the artificial intelligence subsystem 108, or the sensor array 104 and the artificial intelligence subsystem 108 may be implemented in distinct devices.

Generally, the artificial intelligence subsystem is configured for navigation using the natural light polarization pattern of the sky. The polarimetric sensor array 104 senses this pattern and provides corresponding polarization signals (e.g., in the form of a polarization-dependent current measurement) to the artificial intelligence subsystem 108. The artificial intelligence subsystem 108 may be configured to process the signals to output a direction, heading, location, speed, or similar navigational information.

The artificial intelligence subsystem 108 may additionally be configured for glare reduction. In particular, the artificial intelligence subsystem 108 may process a visible light image to remove or reduce glare as informed by the polarimetric sensor array 104. This may be done prior to or simultaneously with feature recognition or other visible light techniques performed on signals captured by the image sensor.

In addition to navigation and glare reduction, other examples of using light polarization to provide useful data or to augment data captured by other techniques are contemplated.

The artificial intelligence subsystem 108 may be implemented on a computing device, such as an example computing device 120 depicted in FIG. 1B.

The computing device 120 may include a includes a processor 124 and a memory 128.

The processor 124 may include a central processing unit (CPU), a microcontroller, a microprocessor, a processing core, a field-programmable gate array (FPGA), or similar. The processor 124 may include multiple cooperating processors. The processor 124 may cooperate with the memory 128 to realize the functionality described herein.

The memory 128 may include a combination of volatile (e.g., Random Access Memory or RAM) and non-volatile memory (e.g., read-only memory or ROM, Electrically Erasable Programmable Read Only Memory or EEPROM, flash memory). All or some of the memory 128 may be integrated with the processor 124. The memory stores applications, each including a plurality of computer-readable instructions executable by the processor 124. The execution of the instructions by the processor 124 configures the device 120 to perform the actions discussed herein. In particular, the applications stored in the memory 128 include an application 132. When executed by the processor 124, the application 132 configures the processor 124 to perform various functions discussed below in greater detail and related to the machine vision operation of the device 120. For example, the application 132 may implement some or all of the artificial intelligence subsystem 108. The application 132 may also be implemented as a suite of distinct applications. Further, some or all of the functionality of the application 136 may be implemented as dedicated hardware components, such as one or more FPGAs or application-specific integrated circuits (ASICs).

In some examples, the device 120 may further include a communications interface (not shown) including suitable components (e.g., transmitters, receivers, antennae, ports, etc.) allowing the device 120 to communicate over wired or wireless links. The device 120 may further include one or more input and/or output devices (not shown), such as displays, buttons, microphones, speakers, and the like.

In various examples, the polarimetric sensor array 104, artificial intelligence subsystem 108, and image sensor 110 (if used) may be provided to the same electronic device or on the same integrated circuit (IC), for example as part of the device 120. In other examples, two or more of these components 104, 108, and 110 may be distant from each other and may be connect by wired or wireless data pathways.

The polarimetric sensor array 104 includes individual polarimetric sensor elements 106 that may be arranged in a grid, similar to a visible-light image sensor, such as a charge-coupled device (CCD) or complementary metal-oxide-semiconductor (CMOS) device. Each polarimetric sensor element may be considered a pixel that corresponds to one or more image sensor elements of an image sensor, if used, for example, a polarimetric sensor element may correspond to one image sensor elements, four image sensor elements, sixteen image sensor elements, or similar group of image elements or image pixels.

The polarimetric sensor array 104 or the individual pixel elements 106 thereof provide an optically controlled polarimetry memtransistor (OCPM). In particular, the OCPM provides polarization sensitivity, nonvolatility, and positive/negative photoconductance. That is, the polarimetric sensor array 104 is photosensitive, and therefore configured to detect incoming light from a field of view 112 of the polarimetric sensor array 104. More particularly, the polarimetric sensor array 104 is sensitive to the polarity or polarization of the incoming light. The polarimetric sensor array 104 may be configured to generate a polarization signal representing the polarization of the incoming light. For example, the polarimetric sensor array 104 may generate different currents according to the polarization of the incoming light. Other sensitivities are also contemplated.

The polarimetric sensor array 104 may further be supported on a rotatable platform 116, configured to rotate the array 104 for detecting the light and to generate the polarization signals according to the reception of the light at different angles relative to the atomic structure of each of the polarimetric sensor elements 106, as further described herein. In other examples, different detection angles of the polarimetric sensor array 104 may be achieved via orientation of the polarimetric sensor elements 106 within the array 104. That is, some sensor elements 106, or subsets thereof may be oriented in different directions in order to detect light at the different angles relative to the atomic structures.

The OCPM can further realize optically-programmed non-volatile states. In particular, the OCPM provides both positive photoconductivity (PPC) and negative photoconductivity, which mimics antagonistic shunting and memory of bipolar cells, demonstrating the sensing function of the retina and the computation function of the visual cortex. The conductance of the device can be gradually increased and decreased by light stimuli, corresponding to long-term potentiation and depression. This can be used to construct artificial neural networks (ANNs) for neuromorphic computing.

Accordingly, the array 104 may encode a set of node weights of at least one layer of an ANN. That is, the array 104 may include an embedded artificial intelligence subsystem, given by the one or more layers defined by the node weights, as stored in the optically-programmed memory of each of the elements 106. The embedded artificial intelligence subsystem of the array 104 may cooperate with the artificial intelligence subsystem 108 to realize the machine vision functionality described herein. In particular, with respect to the glare reduction function of the system 100, the array 104 may receive an input image (e.g., via the image sensor 110 or via sensing capabilities of the array 104 itself), and process the input image via the embedded artificial intelligence subsystem to generate a modified or filtered output for each pixel of the input image. That is, the embedded artificial intelligence subsystem of the array 104 filters the input image. Specifically, the configured node weights of the embedded ANN may be configured for glare reduction filtering, for example via factoring the polarization of the light in the received input. The filtered output may then be provided to the artificial intelligence subsystem 108 to generate an output image for machine vision functionality. In particular, the output image may represent the input image with reduced glare.

In particular, Van der Waals (vdW) heterostructures are promising for optical sensing, memory, and computing. Two-dimensional (2D) materials have excellent optoelectronic properties, atomically thin thickness, high-carrier mobility, and tuneable electrical transports. In particular the OCPM as described herein may include 2D materials with in-plane anisotropic structures which can realize polarimetric functions to lights. The presently described 2D polarimetric devices utilizing atomic-level anisotropy are compatible with complementary metal-oxide semiconductor (CMOS) fabrication techniques. 2D materials devices have the potential to realize high-density integration and excellent scalability. Furthermore, the presently described 2D materials exhibit outstanding memory, and computing capabilities, which are easier to fuse with polarimetry functionalities. Multi-terminal memtransistors based on vdW heterostructures can achieve programmable optoelectronics and complex functions of hetero-synaptic plasticity that can be used for brain-inspired neuromorphic computing. Accordingly, the presently described system 100 seamlessly integrates polarization sensitivity, light sensing, memory, and neuromorphic computing, which will leverage novel AI applications.

Thus, for example, polarimetric sensor array 104 may include a Van der Waals heterostructure formed by stacked layers of rhenium disulfide (ReS₂) and germanium diselenide (GeSe₂) with anisotropic structures. Such a structure may provide the OCPM properties of the polarimetric sensor array 104. For example, the ReS₂/GeSe₂ structure provided both positive photoconductivity (PPC) and negative photoconductivity (NPC) under the light of 808 nm and 405 nm, respectively.

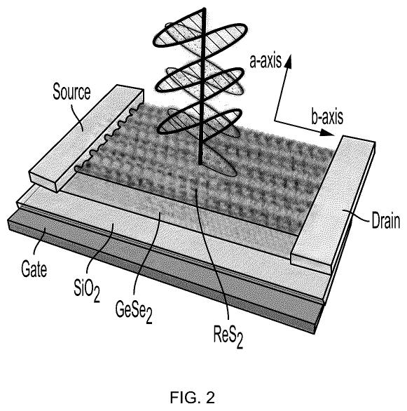

For example, referring to FIG. 2, a schematic diagram of the stacked ReS₂/GeSe₂ structure is depicted.

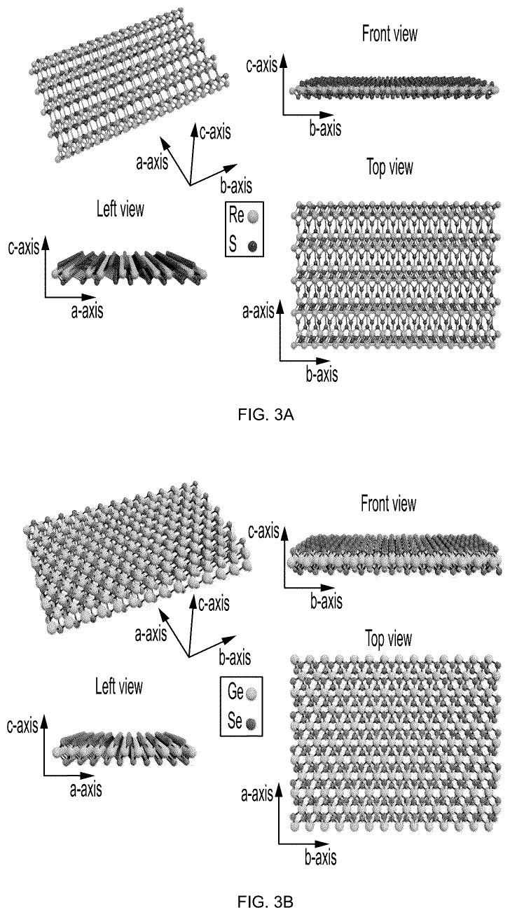

The atomic structures of ReS₂ and GeSe₂ are shown in greater detail in FIGS. 3A and 3B, respectively.

ReS₂ is a transition metal dichalcogenide (TMDC), demonstrating very stable properties in ambient conditions. It is an n-type semiconductor with a direct bandgap. ReS₂ has a distorted 1T structure deriving from the hexagonal structure. A 2D ReS₂ layer is consisting of three atomic layers of ‘S-Re-S’. Re-S forms covalent bonds. Each Re is covalently bonded with 6 S atoms in an octahedral geometry. Each S atom is covalently bonded to three Re atoms. Four Re atoms are constructed into a parallelogram that demonstrates in-planar anisotropy. The anisotropic structure determines bi-axial optical and electrical properties, indicating polarization-sensitive properties. Layers are stacked together due to van der Waals (vdW) forces, similar to other 2D layered materials. For the OCPM in this work, the b-axis direction was defined as the reference direction of the device. The channel current (source-drain current (I_{ds})) flowed along the b-axis of ReS₂.

GeSe₂ is a two-dimensional crystal with a monoclinic crystal structure. GeSe₂ is a layered transition metal dichalcogenide (TMDC). It has a direct wide bandgap that shows excellent optoelectronic properties. The GeSe₂ is a two-dimensional crystal with a tetragonal structure. As depicted in FIGS. 3b to FIGS. 3d, the in-plane directions were defined as the b-axis and a-axis. The in-plane atoms formed covalent bonds, while the layers along the c-axis were bonded by van der Waals forces. The GeSe₄ tetrahedra is the basic building block of GeSe₂, in which (GeSe₄)ₙ chains were formed along the b-axis direction. GeSe₂ has an in-plane anisotropic structure due to different bonding modes along the b-axis and a-axis directions. Notably, anisotropic structures induce anisotropic energy bands, which determined the polarization-sensitive properties. The b-axis direction of GeSe₂ was parallel with the b-axis direction of ReS₂.

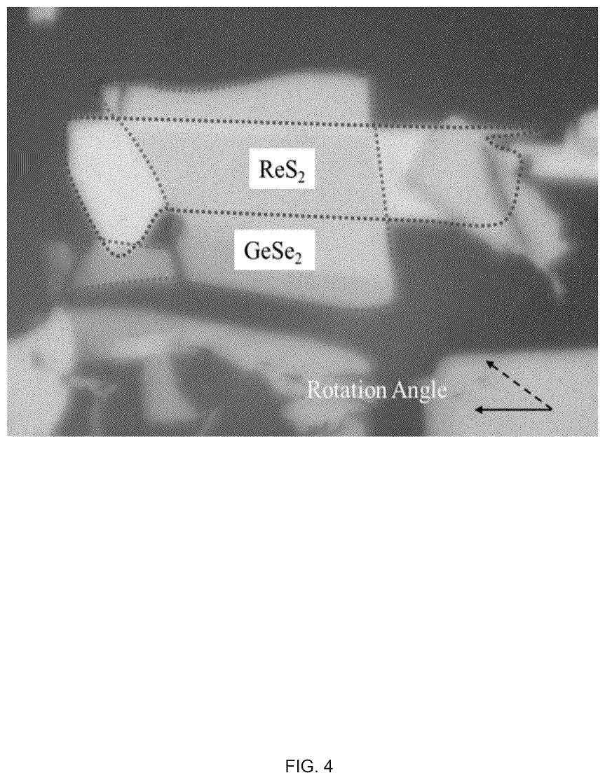

ReS₂ and GeSe₂ have in-plane anisotropic structures and direct bandgaps, indicating excellent bi-axial optical and electrical properties. Polarization-sensitive absorption spectra were measured to further investigate the bi-axial optical properties. FIG. 4 depicts an optical micrograph of the stacked GeSe₂/ReS₂ layer for polarization-sensitive absorption spectra.

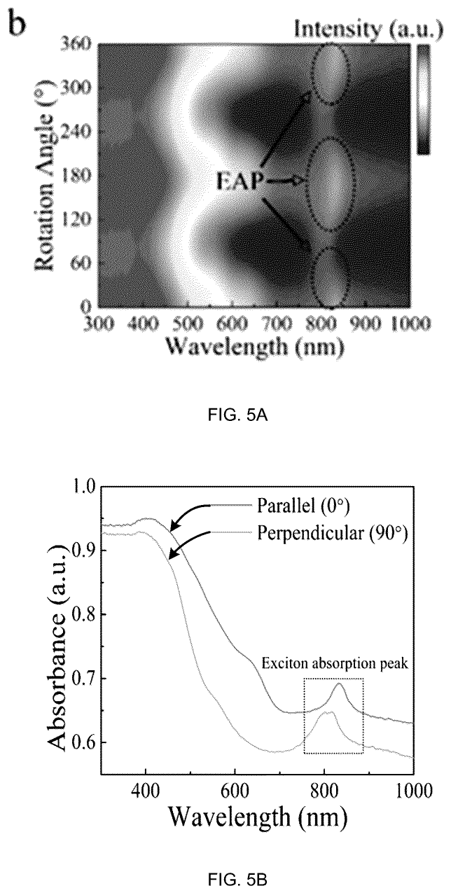

In an experimental setup, a linear polarizer was utilized to polarize the irradiated light. For the initial state (rotation angle=0°), the polarization direction of irradiated light was parallel with the b-axis direction of measure materials. To acquire the polarization-sensitive absorption spectra mapping, the sample was rotated clockwise by an angle of 10° for each step. Polarization-sensitive absorption spectra mapping of the ReS₂ layer was recorded and is depicted in FIG. 5A, where the rotation angle is with respect to the b-axis in-plane clockwise. The results presented an angle-dependent absorption feature, indicating linear dichroic effects. Notably, exciton absorption peaks (EAP) at around 800 nm were observed when the rotation angles were 0° and 180° but were not observed at the 90° and 270° counterparts. Typical polarization-sensitive absorption spectra of ReS₂ under the rotation angle of 0° and 90° were extracted (FIG. 5B). In FIG. 5B, the “parallel” line indicates polarized light which was parallel with the b-axis direction of the ReS₂, and the rotation angle was 0°. The “perpendicular” line indicates polarized light which was perpendicular to the b-axis direction (along the c-axis direction) of ReS₂, and the rotation angle was 90°.

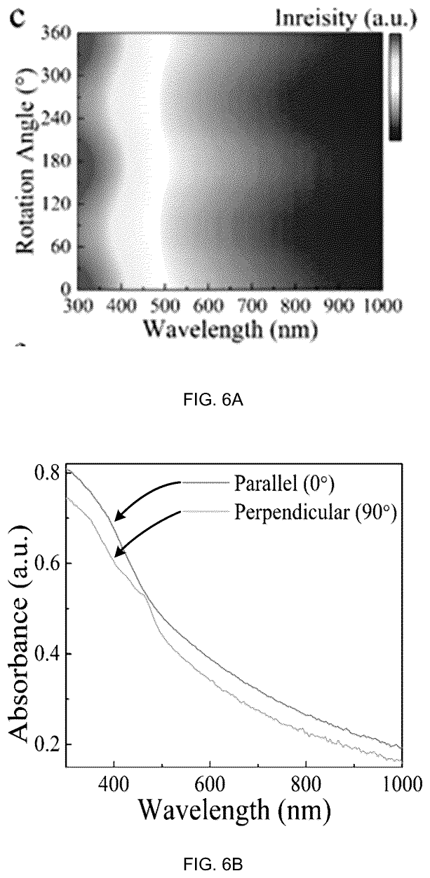

A higher absorption coefficient was observed when the polarized light was parallel with the b-axis of ReS₂ ([010] direction of the ReS₂ crystal) compared to the perpendicular counterpart. Besides, the blueshift feature of absorption spectra was found when the rotation angle increased from 0° to 90°. This implied the anisotropic electronic properties. The polarization-sensitive absorption spectra mapping of the GeSe₂ layer was also measured and is depicted in FIG. 6A, where the rotation angle is with respect to the b-axis in-plane clockwise. An angle-dependent absorption feature was presented with linear dichroic effects. Typical polarization-sensitive absorption spectra of GeSe₂ under the rotation angle of 0° and 90° were extracted, as can be seen in FIG. 6B. The material showed higher absorption ability when the polarized light was parallel with the b-axis of the GeSe₂. The bi-axial optoelectronic properties of ReS₂ and GeSe₂ are the fundamentals of polarimetric capabilities.

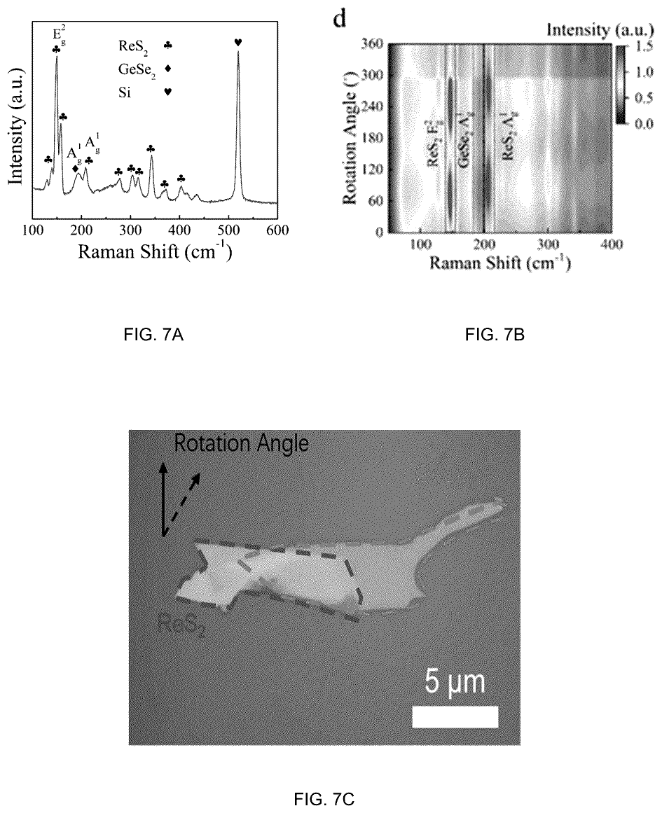

Furthermore, to confirm the anisotropic characteristic of ReS₂ and GeSe₂, the Raman spectra of the materials were measured. The typical Raman spectrum of the ReS₂/GeSe₂ double layer, in particular at the heterojunction, was shown, as can be seen in FIG. 7A. The observed peaks all belong to the used materials as labelled. The peak located at 520 cm⁻¹ was attributed to the substrate of Si. The typical peaks of ReS₂ were located at 149 cm⁻¹ and 209 cm⁻¹ corresponding to the in-plane E²_{g} mode and A¹_{g} modes respectively. The A¹_{g} mode of GeSe₂ was found at 194 cm⁻¹. The angle-resolved polarized Raman spectra of the ReS₂/GeSe₂ bi-layer were measured for investigating anisotropic properties (FIG. 7B). The ReS₂/GeSe₂ vdW heterostructure with aligned b-axis direction was placed on a SiO₂/Si substrate. An optical micrograph of the stacked GeSe₂/ReS₂ layers for angle-resolved polarized Raman spectra is depicted in FIG. 7C. The b-axis direction of stacked GeSe₂/ReS₂ layers was parallel with the polarized light at the beginning (rotation angle=0°) of the measurement. Then the sample was rotated by the step of 10° (GeSe₂/ReS₂ layers rotate together). The corresponding Raman spectra were collected at each step. The angle-resolved polarized Raman spectra mapping is depicted in FIG. 7B. Raman signal amplitudes changed periodically with the increased rotation angles, meaning an anisotropic structure in the in-plane dimension. The classical Placzek model gave an insight understanding to the anisotropic structure. The Raman signal intensity is described by the following equation:

$$S ∝ {\vert {e}_{i} \cdot R \cdot {e}_{s} \vert}^{2} \qquad ( 1 )$$

where S is the Raman signal intensity, eᵢ is the unit polarization vectors described by equation 2:

$${e}_{i} = [ \begin{matrix}0 & cos θ & sin θ\end{matrix} ] \qquad ( 2 )$$

R represents the Raman tensor described as a 3×3 matrix:

$$R = [ \begin{matrix}a & 0 & 0 \\ 0 & b & 0 \\ 0 & 0 & c\end{matrix} ] \qquad ( 3 )$$

eₛ means the unit polarization vectors of scattered Raman signals under the parallel or cross-polarization modes. The parallel mode was used in this work, which is described as equation 4:

$${e}_{s ‖} = \vert \begin{matrix}0 & cos θ & {sin θ \vert}^{T}\end{matrix} \qquad ( 4 )$$

where θ gives the rotation angle. The angle-dependent Raman signal intensity for A_{g} mode under the parallel working mode is described by equation 5:

$${S}_{{A}_{g}}^{‖} ∝ \vert b cos {θ}^{2} + c sin {θ}^{2} {\vert}^{2} \qquad ( 5 )$$

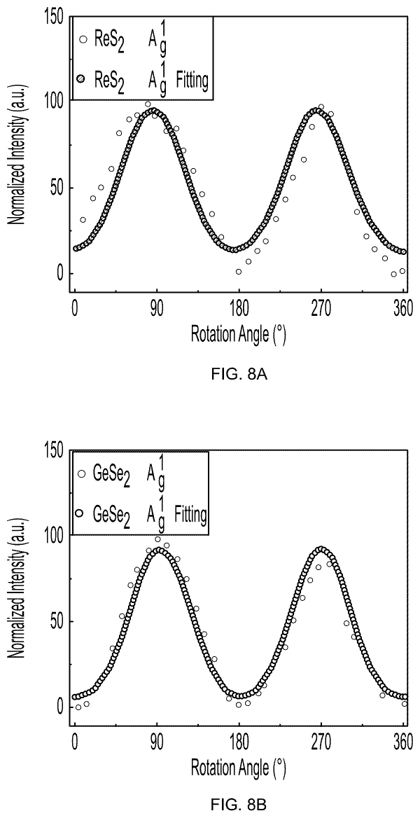

The angle-dependent Raman intensity of the A¹_{g} mode was studied. The experimental and fitting plots of ReS₂ and GeSe₂ are presented in FIGS. 8A and 8B, respectively. Notably, the experimental data points are fitted well with theoretical values. A signature periodic variation feature of 180° was observed for both ReS₂ and GeSe₂. This clearly demonstrating a bi-axial anisotropic structure.⁴³ Besides, the angle deviation of the two materials' orientation (b-axis direction) was merely 6°, which indicates very good alignment.

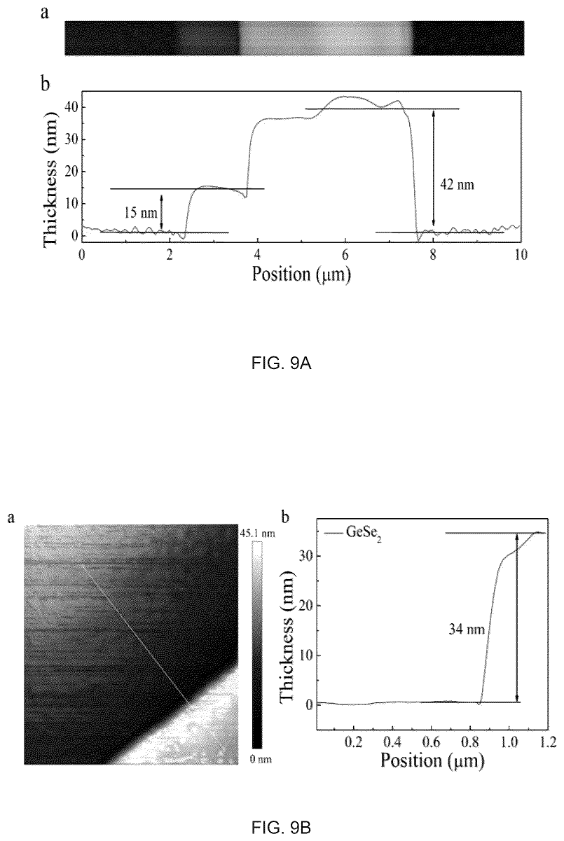

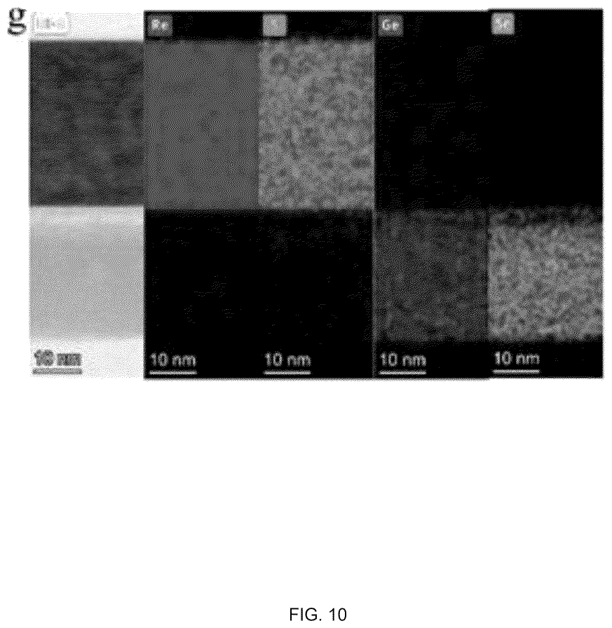

The thickness of ReS₂ and GeSe₂ layers were identified by the Atomic Force Microscopy (AFM). FIG. 9A depicts the AFM image of ReS₂ and the height profile of the ReS₂ layer, and FIG. 9B depicts the AFM image of GeSe₂ and the height profile of the GeSe₂ layer. The thickness of ReS₂ and GeSe₂ for constructing the OCPM were approximately 42 nm and 34 nm, respectively. Meanwhile, the high-angle annular dark-field (HAADF) image was measured to analyse the cross-section of the stacked ReS₂/GeSe₂ structure and the corresponding element distribution, as depicted in FIG. 10. The laminate structure was observed in both ReS₂ and GeSe₂ layers. The Re, S, Ge, and Se were distributed uniformly in the corresponding regions in the energy disperse X-ray spectroscopy elemental mapping. No other impurity elements were found.

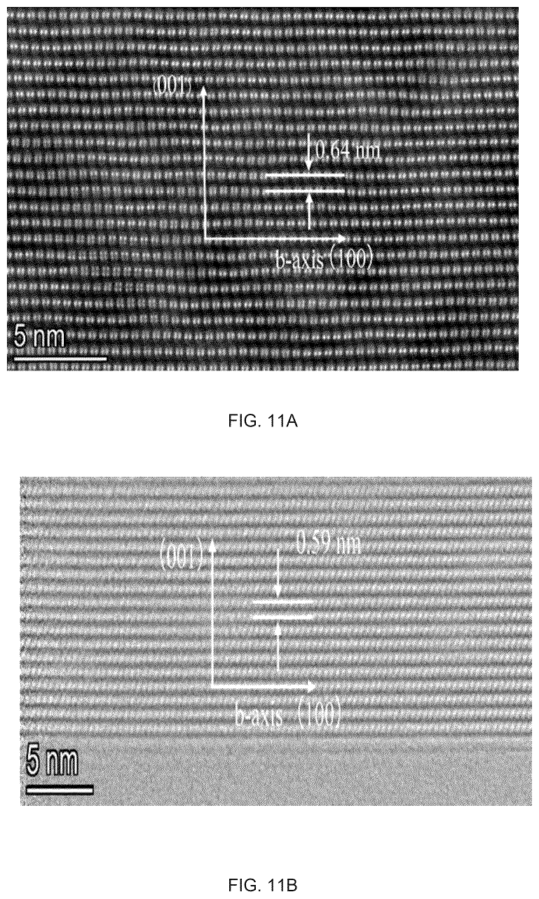

The HAADF atomic scale image of ReS₂ indicated a high crystallinity of the exfoliated ReS₂, as can be seen in FIG. 11A. The HAADF image was measured by aberration corrected scanning transmission electron microscopy (AC-STEM). The interlayer spacing was approximately 0.64 nm along the [001] direction. The atomic scale HAADF image of GeSe₂ also demonstrated a crystalline feature with the interlayer spacing of 0.59 nm, as can be seen in FIG. 11B.

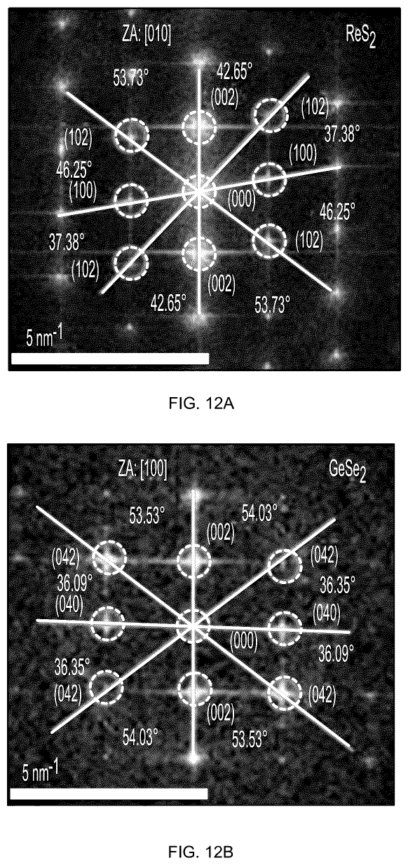

Further, the fast Fourier transform (FFT) patterns were obtained to get more insight into crystalline structures. In the FFT pattern of ReS₂ crystalline as depicted in FIG. 12A, clear spots were observed in the reciprocal space, indicating the single crystalline structure. The FFT spots were consistent with the distorted 1T structure. The angle between (002̅) and (1̅02̅) reflections in ReS₂ was 53.73° which was 11.08° deviating from the angle between (002̅) and (102̅) reflections (42.65°). The angle between crystal planes reflections of (002̅) and (1̅00) in ReS₂ was 99.98° which was 19.95° bigger than that of (002̅) and (100) (80.03°). This confirmed a strong in-plane anisotropy. The corresponding FFT pattern along the [100] zone axis (ZA) of GeSe₂ was detected, as depicted in FIG. 12B. The monoclinic β-GeSe₂ was identified by the FFT pattern. The angle between crystal planes reflections of (002̅) and (040) was 89.62°, which was smaller than that of (002̅) and (04̅0) (90.38°), demonstrating an anisotropic structure. Both optical spectra and atomic structure anisotropies of ReS₂ and GeSe₂ were characterized, which are the fundamentals of bi-axial optoelectronics in the OCPM.

Multilayer GeSe₂ was exfoliated from bulk crystal using Nitto tape and directly transferred onto a highly p-doped silicon substrate that was covered by silicon dioxide (90 nm). ReS₂ was mechanically exfoliated and transferred onto the GeSe₂ flake, which was assisted by an aligned transfer system equipped with an optical microscope. The GeSe₂ holder can be rotated to change the alignment direction. This can fabricate different alignment angles of ReS₂/GeSe₂.

Further, the optoelectronic properties and working mechanism of the OCPM were systematically investigated.

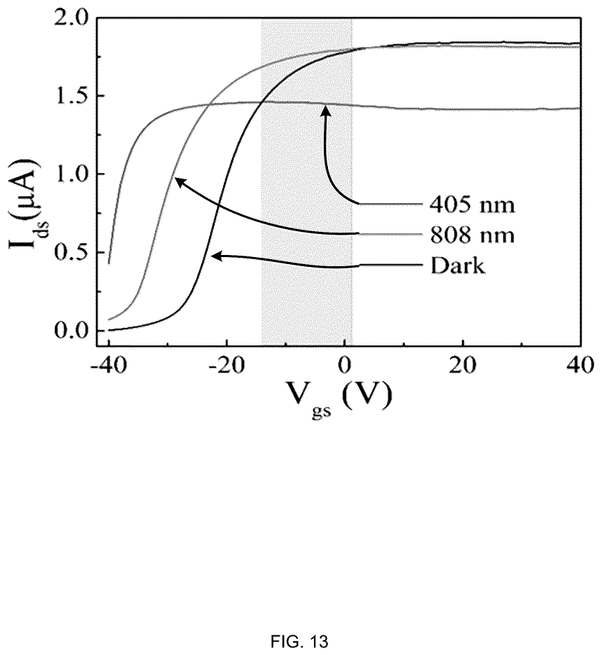

The light-wavelength-dependent transfer curves were measured to identify the operation gate voltage, as depicted in FIG. 13. The light illuminations with the wavelengths of 405 nm and 808 nm were applied to the OCPM individually. The gate voltage effectively modulated the photoconductivity under illumination with different wavelengths. Both positive photocurrents and negative photocurrents were observed with respect to the dark current under a certain gate voltage slot (approximately −14.1 V to 1.4 V) as marked by a grey area. This enabled fully optical-controlled information processing with artificial neural networks (ANN).

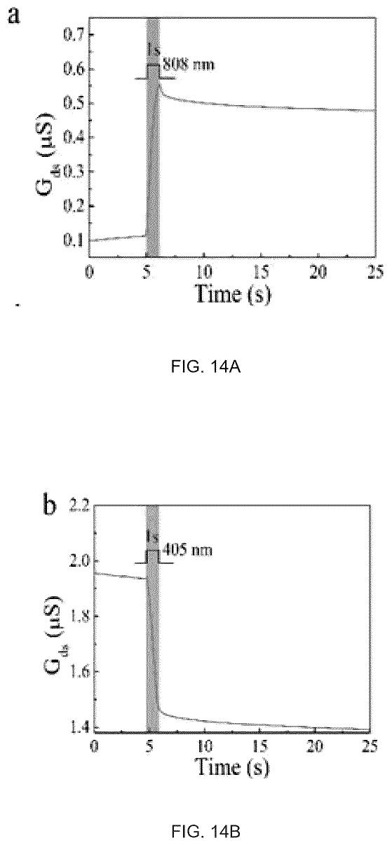

The l-t plot under an unpolarised pulsed light stimulation (808 nm wavelength) indicates non-volatile positive photoconductivity (PPC) properties, with (V_{gs}=−10V), as can be seen in FIG. 14A. The illumination intensity of 808 nm wavelength was fixed as 190 nW/m². This power was used for all the rest of PPC operations without special instructions. The G_{ds} increased quickly as the light shining (808 nm) on the device. Particularly, the current remained at a larger value than the original dark state value after turning off the light illumination. This is a signature character of non-volatile functions.

In comparison, after the device was programmed to the high conductivity by 808 nm, the conductance decreased when the light with the wavelength of 405 nm was shined on the device, and the lowered conductance was remained after the illumination, which meant the non-volatile negative photoconductivity (NPC), with (V_{gs}=−10 V), as depicted in FIG. 14B. The intensity illumination with 405 nm wavelength was fixed as 190 nW/m². This power was used for all the rest of NPC operations without special instructions. This phenomenon indicated a non-volatile negative photoconductivity (NPC).

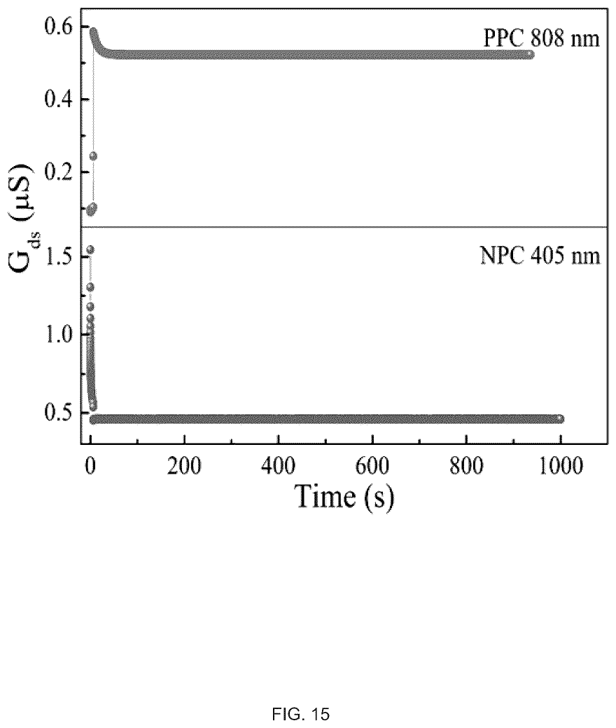

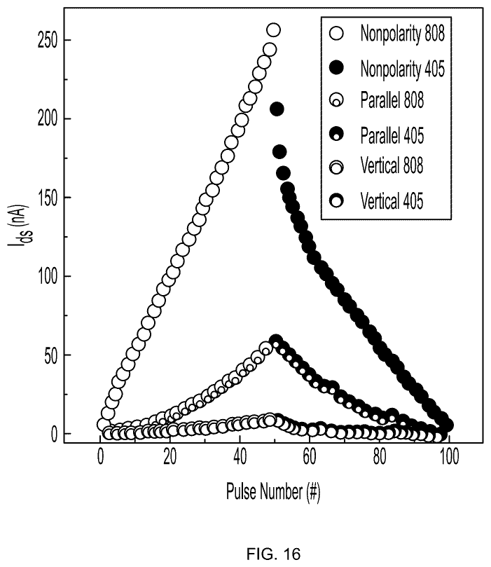

The retention time of the device programmed by pulsed gate voltages was measured and is illustrated in FIG. 15. The programmed currents remained for approximately 1,000 s without any signs of degeneration. The co-existence of non-volatile PPC and NPC shows promising prospects for cognitive information processing based on ANNs. The output currents can be modulated gradually, corresponding to potentiation and depression behaviours, as shown in FIG. 16. In particular, FIG. 16 depicts fully optical-controlled potentiation/depression with polarimetric functions (Light pulse width 10 ms, V_{gs}=−10V, V_{ds}=0.1V).

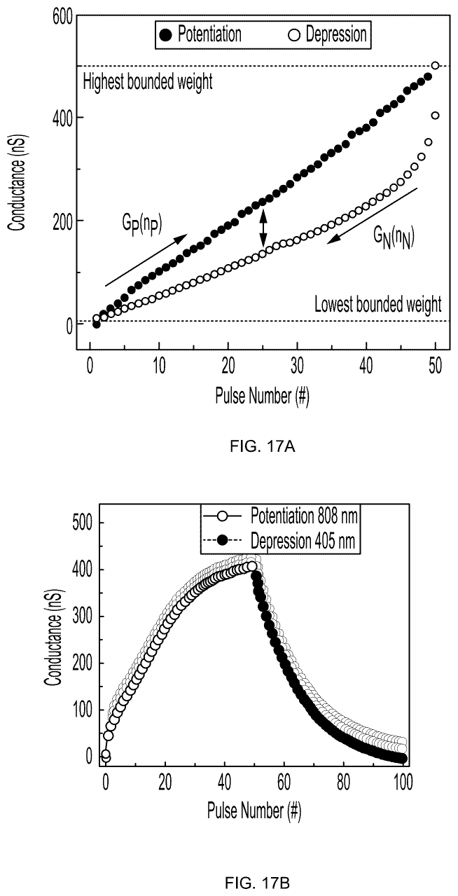

The programmable conductance can represent synaptic weights in ANNs, implementing the matrix-vector multiplication (MVM) for deep learning algorithms. The architecture used lights to program synaptic weights. The photonic device increases processing speed owing to high bandwidth, lowered parasitic crosstalk, and achieves ultralow power consumption comparing with electrical counterpart.⁵¹ Minimizing the asymmetric nonlinearity (ANL) of weight updating (potentiation/depression) is used for computing accuracy. A small ANL of 0.19 was obtained in the OCPM as can be seen in FIG. 17A.

In particular, the value of ANL can be calculated according to the equation (6):

$$ANL = \frac{\vert {G}_{P} ( \frac{N}{2} ) - {G}_{D} ( \frac{N}{2} ) \vert}{{G}_{max} - {G}_{min}} \qquad ( 6 )$$

where G_{P} and G_{P} are the conductance of potentiation and depression, respectively. N means the maximum number of applied pulses. Gₘₐₓ and Gₘₐₓ are the maximum and minimum conductance over the programmable conductance range. The ANL of the OCPM controlled by photons was 0.19% which was comparable with electronic-controlled weight updating.

The feature was comparable with the electronic-controlled artificial synapses. Further, the device was operated for over 30 cycles without obvious variation of conductance. In FIG. 17B, one full potentiation (50 light pulses with the wavelength of 808 nm) and depression (50 light pulses with the wavelength of 405 nm) were defined as one cycle. The device was operated for 30 cycles without obvious variation of conductance. (Pulsed width: 10 ms, Power: 3 μW, V_{ds}=0.01V). In particular, the OCPM also endowed polarization-sensitive potentiation/depression abilities. This can realize image preposing with polarimetric functions and in-sensor computing simultaneously, which goes beyond traditional humanoid machine vision.

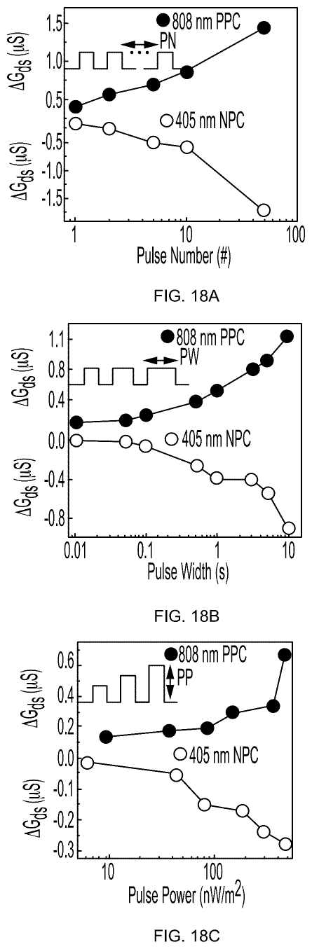

Moreover, conductance modulations under multiple optical pulses with different pulse numbers (PN), pulses widths (PW), and pulse power (PP) were characterized, and are illustrated in FIGS. 18A, 18B, and 18C, respectively. Identical neurological responses to different stimuli are essential in biological brains associating to learning and memory. More stimuli, higher frequent stimuli, and stronger stimuli trigger more intensive or more suppressive neurological responses and feedback. Bidirectional synaptic excitation and inhibition are the foundation for information processing in brains. Pyramidal cells in the primary visual cortex need to equalize excitation/inhibition ratios for visualization tasks. Conductance changes (ΔG_{ds}) under different light PNs were tested. The absolute ΔG_{ds} increased monotonically with the increase of PNs (PN from 1 to 50). The ΔG_{ds} of PPC increased from 0.41 μS to 1.44 μS. The absolute ΔG_{ds} of NPC increased from 0.17 μS to 1.73 μS, which indicates spike-number-dependent plasticity (SNDP) mimicking biological systems. Meanwhile, the PPC induced by 808 nm light was more obvious with longer pulse widths (PW varied from 10 ms to 10 s). ΔG_{ds} was 0.1 μS under the shining of a 10 ms pulse. In comparison, ΔG_{ds} enlarged to 1.24 μS with a pulse width of 10 s. The 405 nm light also induced SRDP phenomena regarding the NPC behaviour. The absolute values of ΔG_{ds} increased from 0.02 μS (PW of 10 ms) to 0.92 μS (PW of 10 s). Besides, the mimicking of biological spike-amplitude-dependent plasticity (SADP) was studied. Typical PP-dependent increase of ΔG_{ds} was measured. The ΔG_{ds} of PPC changed from 0.14 μS (10 nW/m²) to 0.67 μS (619 nW/m²). Meanwhile, the absolute ΔG_{ds} of NPC changed from 0.14 μS (6 nW/m²) to 0.28 μS (499 nW/m²). The tuneable PPC and NPC responses in the OCPM provided more operational freedoms for sensing, memory, and bio-inspired neuromorphic computing.

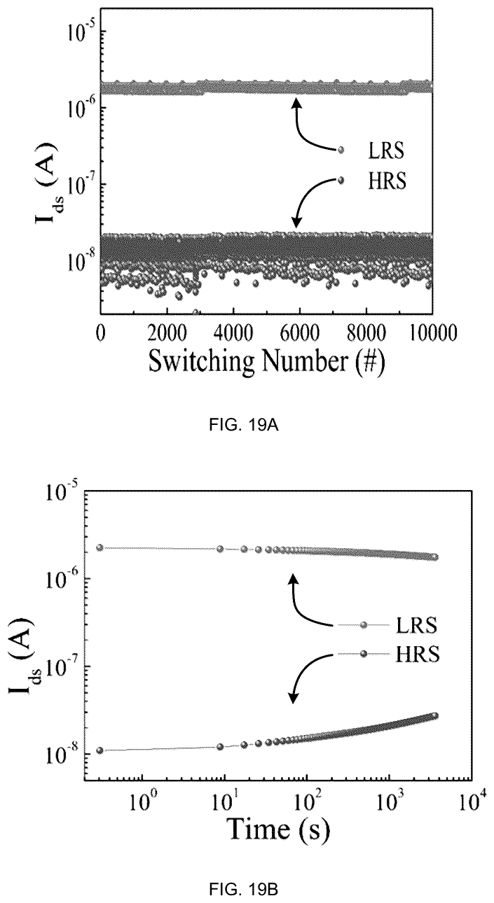

The endurance of the OCPM was tested by programming the device with electronic stimuli as illustrated in FIG. 19A. The high resistance state (HRS) was obtained by applying a positive voltage pulse (V_{gs}=40 V, pulse width=2 ms, V_{ds}=1V). The low resistance state (LRS) was obtained by applying a negative voltage pulse (V_{gs}=−40 V, pulse width=2 ms, V_{ds}=1V). No degradation was observed after 10,000 switching cycles, demonstrating excellent reliability. Further, as depicted in FIG. 19B, the retention time of the programmed states was longer than 3,000 s. The retention time was tested with V_{gs}=±40V, pulse width=2 ms, V_{ds}=1V.

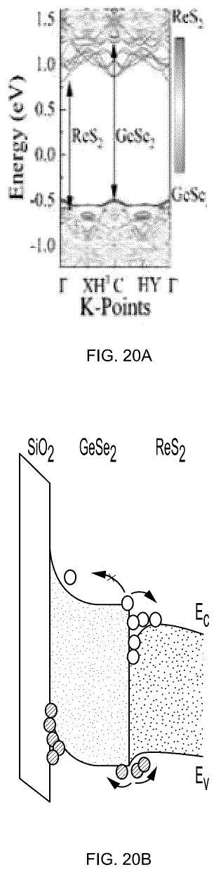

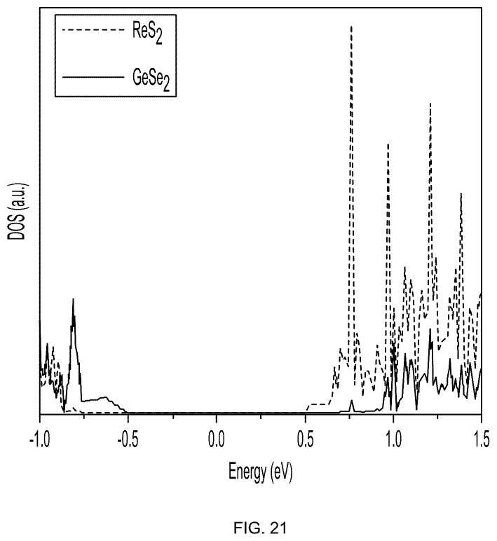

The working mechanism of the OCPM has been investigated. The density functional theory (DFT) was employed to calculate the energy band structure of the ReS₂/GeSe₂ heterojunction, which is depicted in FIG. 20A. The corresponding density of states (DOS) curves are presented in FIG. 21. The GeSe₂ possessed a large band gap compared to the ReS₂ counterpart. The conduction band offset at the interface was relatively big. Electrons were difficult to overcome the energy barrier and flow from the conductance band of ReS₂ to the conductance band of GeSe₂. Meanwhile, the valance band offset was small. In particular, FIG. 20B depicts a schematic diagram of the bandgap alignment of the ReS₂/GeSe₂ heterojunction. It was easier for holes to flow between the valance band of the ReS₂ and GeSe₂.

First-principles calculations were performed using the projector-augmented wave (PAW) method as implemented in the Vienna ab initio simulation package (VASP). The Perdew-Burke-Ernzerhofer (PBE) formula within the generalized gradient approximation (GGA) was used to describe the exchange correlation. The DFT-D2 method of Grimme was used to describe the vdW heterostructure interaction. The vacuum region of 20 Å was set along the x direction to avoid virtual interaction between adjacent images for 2D vdW heterostructure. The cutoff energy was 450 eV. All the structures were relaxed until the forces on all unconstrained atoms were smaller than 0.01 eV/Å, and the total energy convergence criterion was 10⁻⁴ eV.

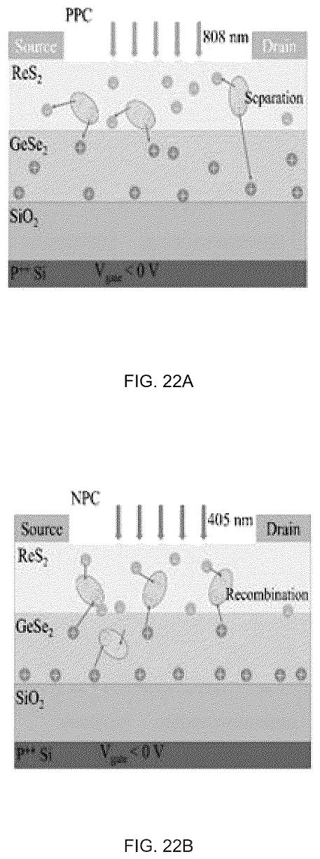

The working mechanisms of PPC and NPC are schematically depicted in FIGS. 22A and 22B, respectively. To achieve optical-controlled conductance modulation, a gate voltage of −10 V was applied. For the PPC behaviour, the light (wavelength of 808 nm) generates majority of excitons in the ReS₂ layer due to the strong absorption of ReS₂ comparing to GeSe₂ at this wavelength. This can additionally be seen in the absorption spectra of FIGS. 5B and 6B, respectively. This was experimentally confirmed by the absorption spectra mapping depicted in FIGS. 5A and 6A. The generated holes in the ReS₂ layer moved to the GeSe₂ layer due to a small valance band offset at the ReS₂/GeSe₂ interface. The generated electrons were left in the ReS₂ layer due to this separation of charge carriers, resulting in increased current (PPC responses). At the same time, holes were trapped at the interface of GeSe₂/SiO₂ due to the negative gate voltage. The trapped holes in GeSe₂ attracted electrons to stay in the ReS₂ layer at increased conductance, demonstrating non-volatile properties.

As for the NPC, light with a wavelength of 405 nm was used to decrease the conductance of the ReS₂ channel. When the light was shined on the device, hole-electrons pairs were mainly generated in the GeSe₂ layer due the larger area. Hole charges were attracted to the SiO₂ layer due to the negative gate voltage and trapped at the interface GeSe₂/SiO₂. Some holes moved from GeSe₂ to the ReS₂ side owing to the small valance band offset and combined with electrons in ReS₂, which decreased the carrier density in the ReS₂ layer. Meanwhile, the electrons generated in the GeSe₂ also migrated to the ReS₂ side, but they were mainly trapped at the ReS₂/GeSe₂ interface, which was due to the quantum well formed by energy band bending. Those trapped electrons did not contribute to conductivity. The ReS₂/GeSe₂ heterostructure has bi-axial optoelectronic properties due to in-plane anisotropic structures. This was the basis for the PPC and NPC with polarimetric functions.

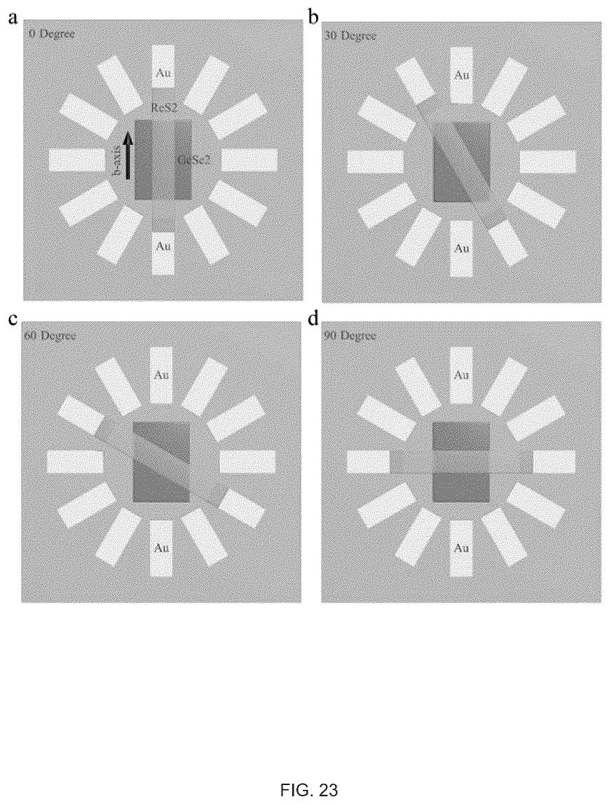

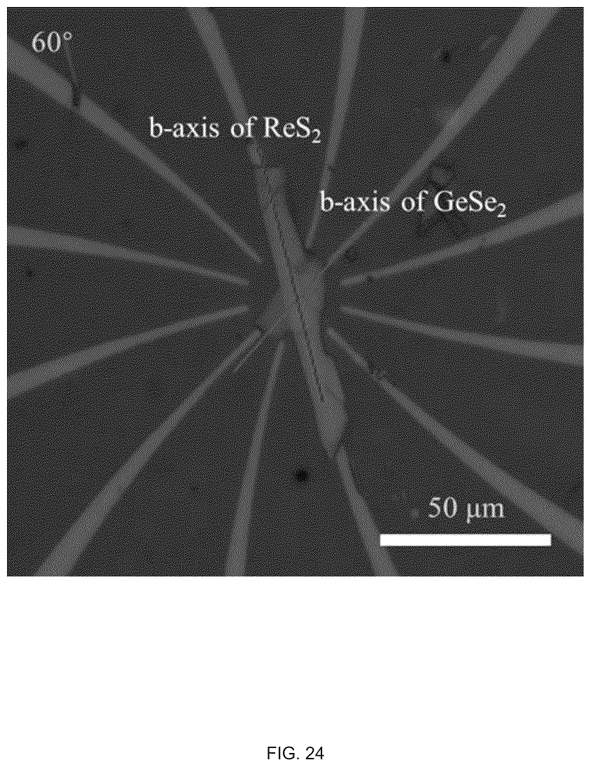

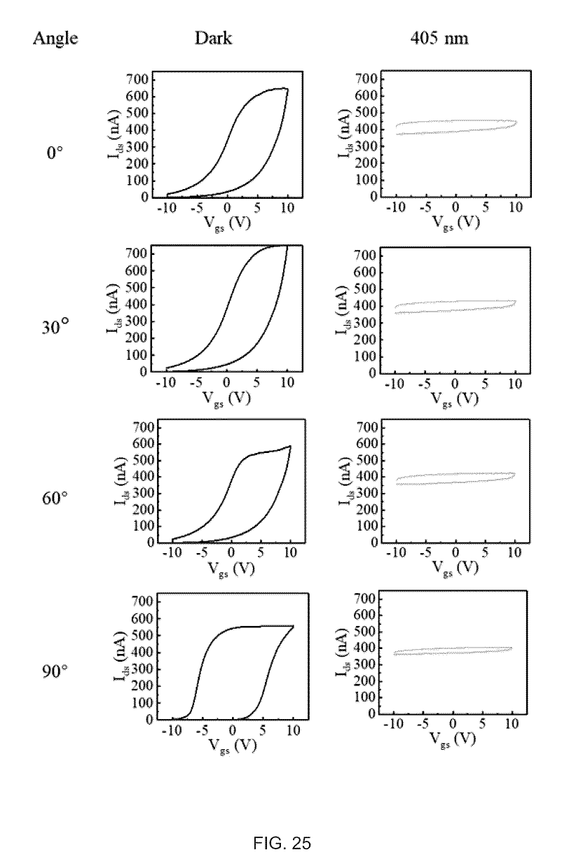

Moreover, the influence of the twist angles (the twist angle between the b-axis of ReS₂ and the b-axis of GeSe₂) on optoelectronic responses has been investigated. The twist angle in the twistronic optoelectronic devices was adjusted from 0° to 90° by in-situ rotating the ReS₂ layer as can be seen in FIG. 23. A typical optical microscopy image of the twistronic optoelectronic device with 60° is depicted in FIG. 24. The polarized light with 405 nm wavelength was used to modulate the optoelectronic properties. The linear polarization direction was fixed and was parallel with the b-axis of GeSe₂. The I_{ds}-V_{gs} curves with different twist angles between ReS₂ and GeSe₂ were measured and are depicted in FIG. 25. The suppression of current amplitude was obtained for all angles, corresponding to NPC responses. A negligible difference was observed when changing the angle between ReS₂ and GeSe₂. This means that the alignment angle of anisotropic ReS₂ and GeSe₂ barely affected NPC responses. The recombination and trapping of electrons were the main reasons for suppressed photocurrents. This is consistent with previous report on heavily doped Si nanowires.

Accordingly, as described herein, the system 100 with an OCPM-based polarimetric sensor array 104 is configured for multiple machine vision functions, including image sensing, polarimetric measurement, and optical-controlled synaptic weights. The sensory functions realize front-end image sensing, which is the input for high-level back-end cognitive tasks. On the other hand, the fully optical-controlled conductance can represent the weight updating in ANNs. We demonstrate that OCPM arrays deploy deep learning algorithms for cognitive tasks. Moreover, the ability of polarimetric measurement can be used for navigation and anti-glare pattern recognition, which goes beyond traditional humanoid machine vision and revolutionizes interspecies-chimera machine vision.

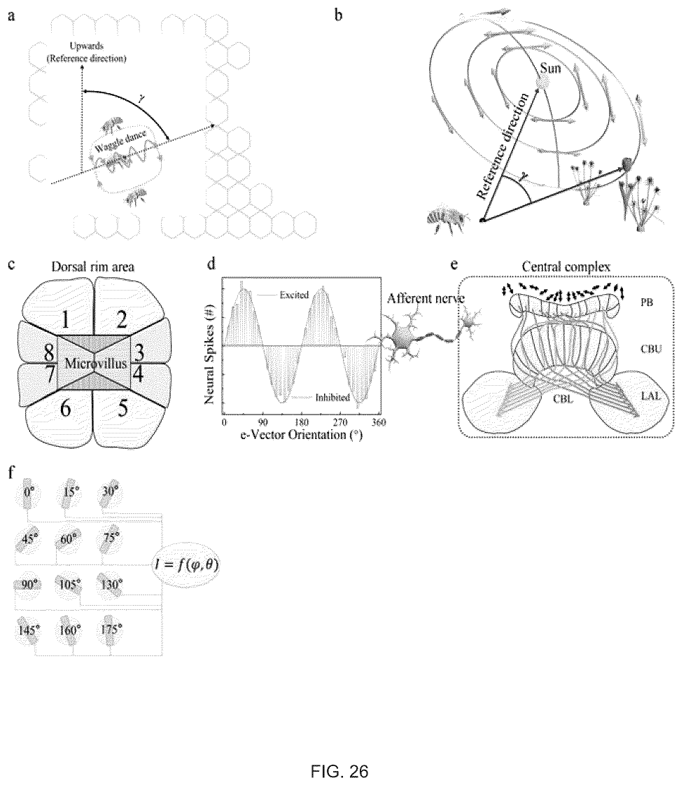

In particular, many animals (for example, honeybees) rely on the sun compass for spatial orientation. They can effectively identify directions even in poor weather (e.g. invisible sun, cloudy) by measuring the celestial polarization patterns, which cannot be done by human eyes. Honeybees are masters at real-time navigating to attractive flower patches with the help of polarised-light patterns. A scout honeybee uses waggle dance (waggles back and forth as moving forward in a straight line) on the honeycomb to transmit the location information to its nestmates, for example as depicted in FIG. 26A. The waggle phase gives the distance information from their hive to the follower. The angle between the waggle segment's axis and the upwards of the honeycomb (a reference direction defined by honeybees living in the hive) represents the angle between the sun and the fly direction. The reason that a honeybee can real-time navigate is that they can measure the polarized light in the sky. Even on cloudy days, they can steer correctly on the way to the target owing to inferring the sun's position by measuring the pattern of polarized light (FIG. 26B). The major components of polarization-vision pathways for identifying navigation maps are demonstrated (FIGS. 26C-E). The cross-section of a dorsal rim area (DRA, special ommatidia at the dorsal margin of compound eyes) shows orthometric microvillus that is sensitivity to polarized light. It possesses polarization-sensitive photoreceptors and orthogonal microvilli. Horizontal regions are labelled as 3, 4, 7, and 8. Perpendicular regions are labelled as 1, 2, 5, and 6. The input light with different polarizations received by DRA triggers excited and inhibited neural spikes, which will be transformed into the central complex via afferent nerves (the medulla, the accessory medulla, posterior optic tubercle, etc.) for further processing and finally identify the navigation directions. The functions of DRA can be realized by orthogonal positioned OCMP arrays for polarization measurements. Notably, polarization-sensitive synaptic plasticity can be mimicked by OCMP with both excitation and inhibition capabilities. The OCMP realizes fetterless, polarizer-free, and miniaturization for polarization navigation, avoiding bulky configurations with separated filters and polarizers. This demonstrates that OCMP is an excellent candidate building block for real-time navigation systems.

In the sky, the polarized sunlight is symmetrically distributed about the solar meridian (SM). The polarization direction (PD) is perpendicular to the direction of SM. Therefore, direction identification can be achieved by measuring the direction of SM or PD. As a proof-of-concept, the navigation accuracy was experimentally evaluated. A typical cloudy day was selected. In practical application, the degree of linear polarization is smaller than 60%, which is calculated by the equation (I_{∥}−I_{⊥})/(I_{∥}+I_{⊥}). I_{∥} and I_{⊥} are light intensities along two perpendicular directions. It is challenging to effectively detect weakly polarized skylights with monolithic polarization-sensitive devices. The perceptive architecture of OCPM array coupling with algebraic analysis can realize navigation applications (FIG. 26F).

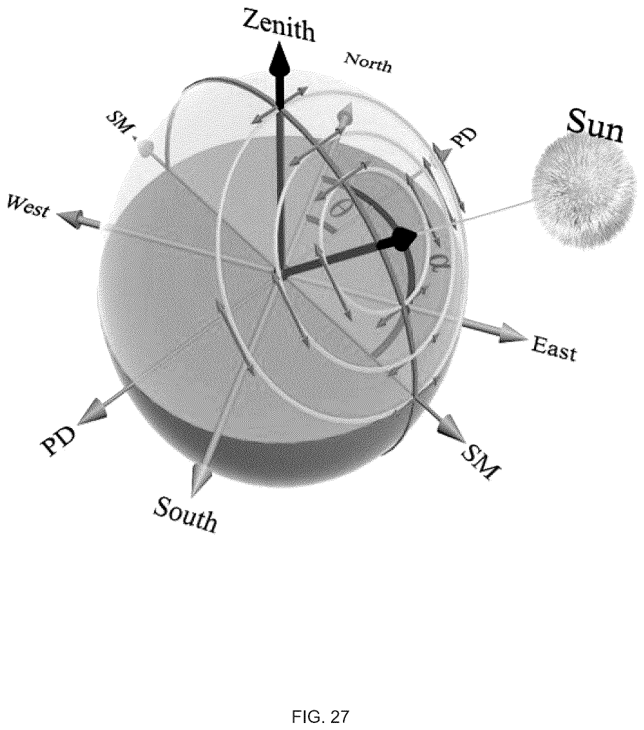

In particular, referring to FIG. 27, a schematic illustration of a polarization pattern determined by the position of the sun is illustrated. Light can be defined as an electromagnetic wave consisting of electronic and magnetic fields perpendicular to each other. The two fields are orthogonal with respect to the heading direction of the light. The e-vector (the orientation of these fields) of the light can be changed to generate polarized light. Typically, the scattered light by molecules, small particles, aerosols, etc. is polarized light, which is described by the Rayleigh sky model. The distance between the spot taking place light scattering and the sun determines the fraction of linearly polarized light. The fraction is smaller when it is closer to the sun. Generally, all e-vectors in the sky are oriented along the circle centred on the sun. Measuring the distribution of e-vector (the pattern of polarized light in the sky) can identify the solar azimuth angle (α) even when the sun is not visible (hidden in clouds).

The celestial polarization pattern is symmetrical about the solar meridian (SM) based on the single-scattering Rayleigh model. The polarization direction (PD) (or e-vector E) is perpendicular to the SM. Monitoring the direction of PD to deduce the direction of SM is the basis of honeybee-biomimetic navigation. Particularly, the OCPM is sensitive to polarized natural light, which simplifies the system's complexity due to the filter-free and polarizer-free features. To demonstrate the practical applications, the OCPM was tested outdoors to measure the SM direction. The crystalline b-axis of ReS₂ and GeSe₂ was initially aligned with the north, which was defined as 0°.

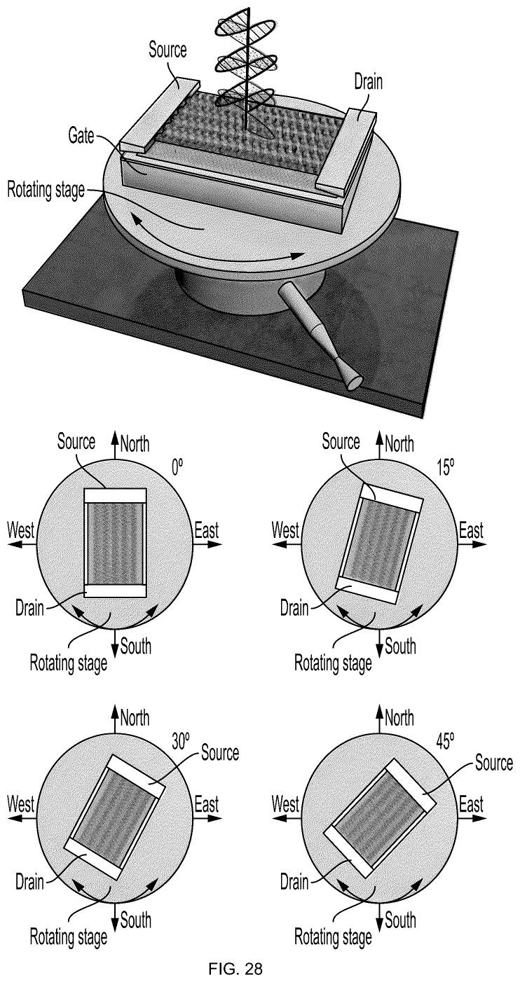

A schematic diagram of an experimental test setup for measuring celestial polarization patterns is shown in FIG. 28A. The OCPM was tested outdoors with natural skylights. No packaging processing was implemented. The device exhibited excellent resilience to fluctuating temperature and humidity, which indicated remarkable chemical stabilities and photoelectronic properties. FIGS. 28B-E depict schematic diagrams of device orientations with different angles between the north and the b-axis direction of ReS₂ crystal. The angle-dependent I_{ds} was recorded stepwise. The OCPM was rotated 15° clockwise for each step with respect to the reference direction of north (the b-axis of ReS2 pointing the north and south was defined as 0°). The device was sensitive to light polarization at both HRS and LRS. To identify the PD, the angle-dependent I_{ds} curve was fitted with the following equation (7):

$${I}_{ds} = {I}_{Parallel} {cos}^{2} ( φ - θ ) + {I}_{Perpendicular} {sin}^{2} ( φ - θ ) \qquad ( 7 )$$

where I_{Parallel} and I_{Perpendicular} are the I_{ds} along the parallel and perpendicular to PD, respectively. φ is the angle between the device direction and the reference direction (north). θ is the angle between the PD and the reference direction (north).

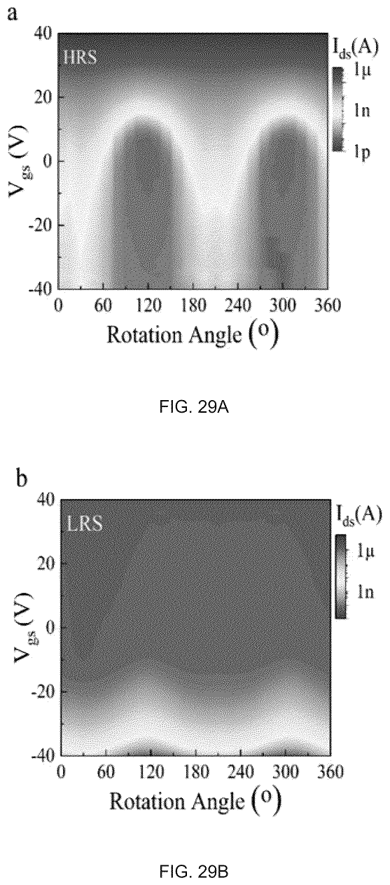

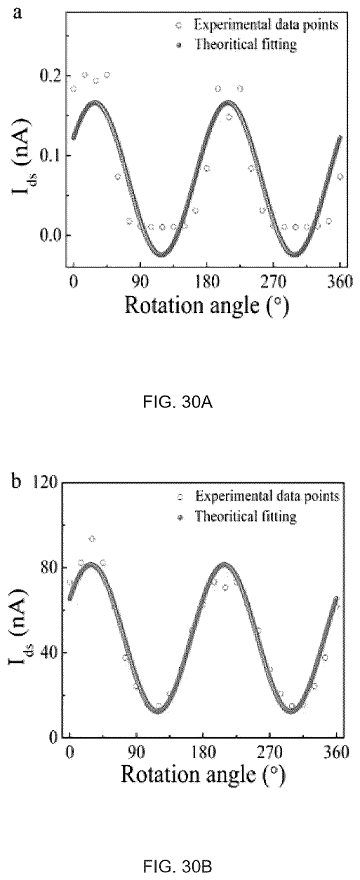

Polarization-dependent I_{ds}-V_{gs} mapping was measured and is depicted in FIGS. 29A and 29B at HRS and LRS, respectively, with V_{ds}=1 V. The results showed angle-depended current amplitudes. The typical experimental data points and fitting results for both HRS and LRS are shown in FIGS. 30A and 30B, respectively. In particular, the polarization channel currents (I_{ds}) were measured outdoors with the location of the test being in Zhengzhou, Henan, China (113.9° E, 35.3° N) on the date Mar. 12, 2023.

The reconfigurable electronic feature makes it more compatible with other ancillary circuits. Because the operation currents have different margins in two HRS (0-0.2 nA) and LRS (20-94 nA) working models, which can have a better compatibility with a wider range of peripheral circuits.

The fitting curve matched well with experimental results. The values of φ were obtained for HRS and LRS was 29.3° and 29.6° respectively, which can be utilized to deduce the direction of SM.

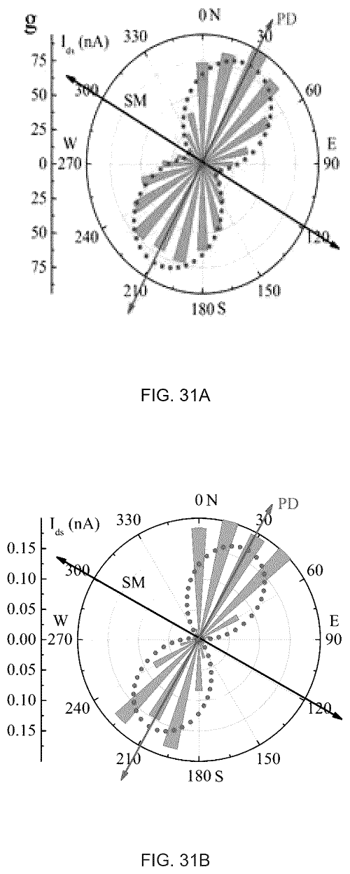

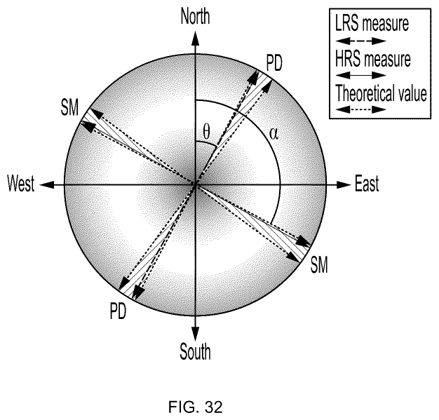

Typical polar coordinate plots of angle-dependent I_{ds} at LRS (FIG. 31A) and HRS (FIG. 31B) were measured. The experimentally measured SM angle was 119.3° (PD angle of 29.3°) and 119.6° (PD angle of 29.6°) under HRS and LRS working models respectively, with the dashed line representing the fitting results. As can be seen, the results were very close with a relative deviation (RD) of merely 0.12% (RD=|SM_{HRS}−SM_{LRS}|/(SM_{HRS}+SM_{LRS})), demonstrating the consistency of the two working models. The experimental results were compared with the theoretical values, as depicted in FIG. 32.

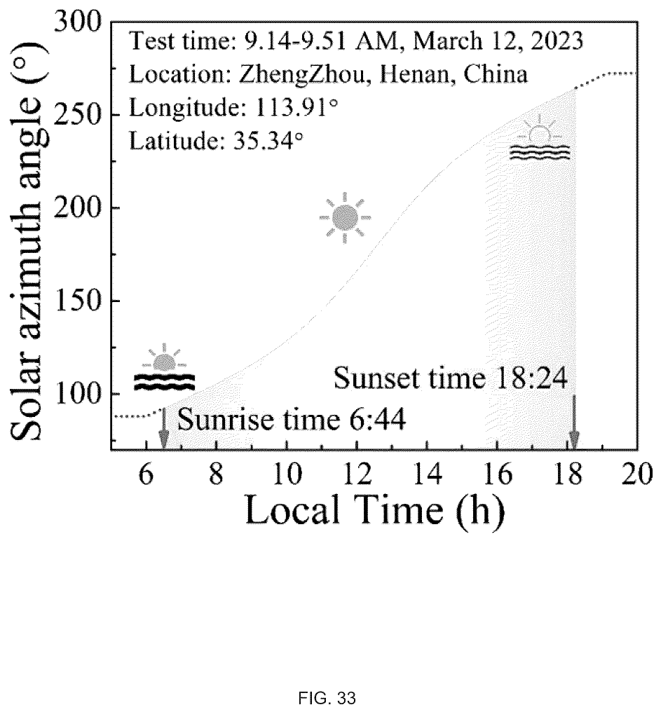

The evolution of solar azimuth angle over a day can be calculated as shown in FIG. 33, with the north being employed as the reference direction (north was 0°). The theoretical α was 118.8°-126.7° over the measuring time slot (9:14-9:51 AM), corresponding to the θ of 28.8°-36.7° (PD direction relative to the north direction). The red and blue arrows represent the measured results with the device at LRS and HRS respectively. The experimental values with OCPM were located right in the theoretical slot, demonstrating a high navigation accuracy and practical applications.

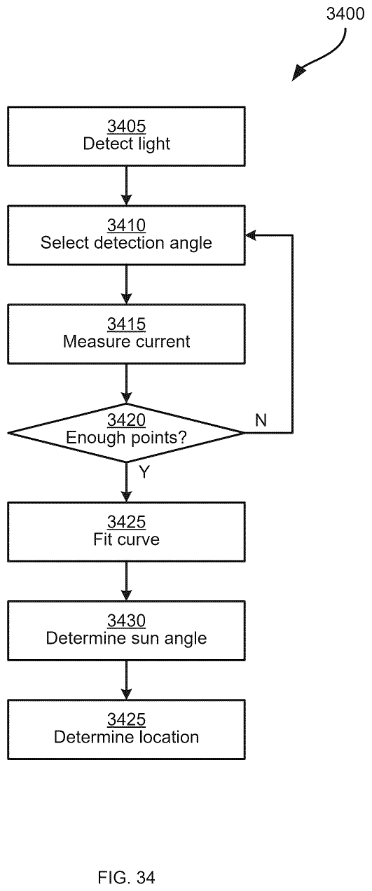

Thus, based on the experimental results, the polarization sensitivity of the system 100 can be used for real-time navigation inspired by honeybees. Specifically, referring to FIG. 34, a flowchart of an example method 3400 of real-time navigation is depicted. The method 3400 will be discussed in conjunction with its performance in the system 100; in other examples, the method 3400 may be performed by other suitable devices or systems.

At block 3405, the system 100, and more particularly, the polarimetric sensor array 104 detects incoming light representing one or more objects and/or the environment within the field of view 112 of the array 104.

At block 3410, the system 100 selects a detection angle at which to arrange the array 104. The detection may be relative to a reference direction, which may preferably be a known direction, such as North, but in other examples may be an arbitrarily selected reference direction, for example based on the application of the navigation method 3400. For example, the system 100 may rotate the rotatable platform 116 to the selected detection angle. In other examples, when multiple sensor elements 106 are disposed within the array 104 at different angles, the system 100 may select the subset of the sensor elements 106 which are angled at the selected detection angle.

At block 3415, the system 100 is configured to measure a current detected by the array 104 (or subset of sensor elements 106 thereof). In particular, the OCPM nature of the sensor elements 106 and the array 104 causes the current to be polarization dependent, and accordingly the current acts as a polarization signal representative of the polarization of the detected light.

At block 3420, the system 100 determines whether a sufficient amount of polarization signals or points (i.e., current values at different detection angles) have been collected. For example, the system 100 may have a predefined threshold number of points (e.g., 10, 16, etc.), e.g., based on a predefined number of detection angles through which the array 104 is to rotate, or the like.

If the determination at block 3420 is negative, then the system 100 returns to block 3410 to select another detection angle to obtain another point.

If the determination at block 3420 is affirmative, then the system 100 proceeds to block 3425.

At block 3425, the system 100 is configured to fit a curve to the combination of polarization signals and detection angles obtained. For example, the system 100 may apply the curve given by equation (7) to the points.

At block 3430, according to the curve fitting at block 3425, the system 100 may determine the value θ as the angle between the PD and the reference direction.

At block 3435, the system 100 may determine a location of the system 100 based on the value θ. In particular, the value θ may represent the solar azimuth angle (i.e., relative to the North direction as a the reference direction) and hence the system 100 may apply the solar azimuth angle to determine the location given by a latitude and longitude of the system 100. In other examples, such as if the reference direction is not objectively known, the system 100 may apply the value θ to determine a relative location, for example for navigation to and from a given starting point, or the like. In still further examples, other known constants may be applied to enable objective location determination and/or navigational functions.

In some examples, in addition to navigational capabilities, human-bee chimera machine vision integrates polarimetry and cognitive recognition functions, which overmatch traditional neuromorphic vision systems. Reflected light from a surface (usually non-metallic) is linearly polarized. The reflected light is usually very strong, inducing glare spots that will distort visualized images and decrease cognitive accuracy in machine vision. Specifically, automatic vehicles and drones use real-time sensing and processing traffic information. Therefore, three major challenges for image processing in automatic machines are sensing and processing accuracy, computing speed, and energy consumption. However, reflective materials used in buildings, advertising boards with smooth surfaces, and a body of water produce lots of glare spots. This will exacerbate the processing accuracy and increase the risk. Note, the formation of glare spots is because the reflected light is polarized light parallel to the surface. The polarimetric capabilities of OCPM can filter the polarized light and reduce the influence of glare spots. Besides, fully optic-controlled synapse can be used to build ANNs for cognitive pattern recognition. An anti-glare machine vision can be developed by integrating polarimetric and synaptic functions.

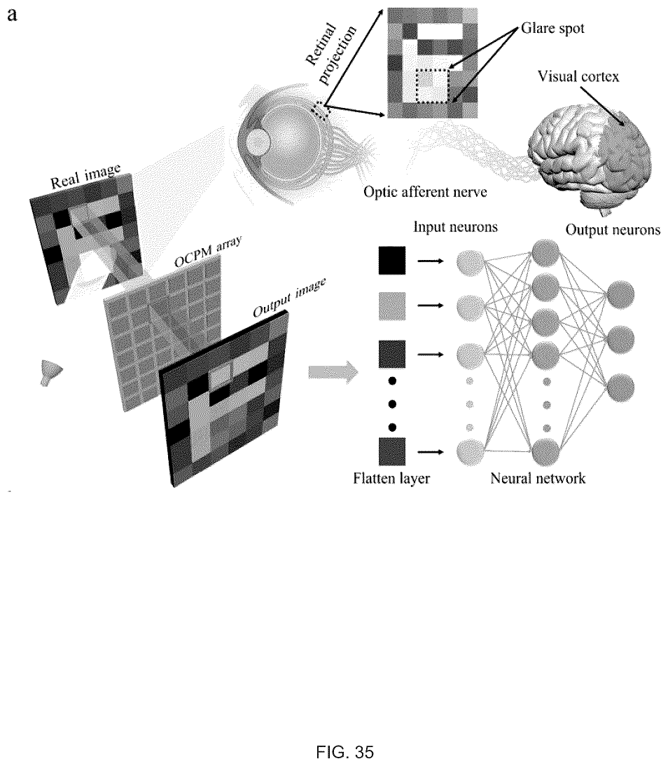

The comparison between human vision systems and OCPM-based honeybee-chimera machine vision is illustrated in FIG. 35. A real image with glare spots is sensed by photoreceptors in human eyes. The image is projected on the retina. Human eyes cannot reduce the intensity of glare spots on images. The projected image reserves the glare spot that distorts the picture of the letter “F”. The image will then be transformed into the visual cortex via optic afferent nerves for cognitive processing. The remained spot glare will influence the processing accuracy due to the distortion and partial-missing of the image. In comparison, the impact of spot glare can be obviously suppressed with the OCPM array thanks to the polarimetric ability. Specifically, the OCPM array can perform as ANNs implementing deep learning for cognitive tasks, mimicking the function of the visual cortex.

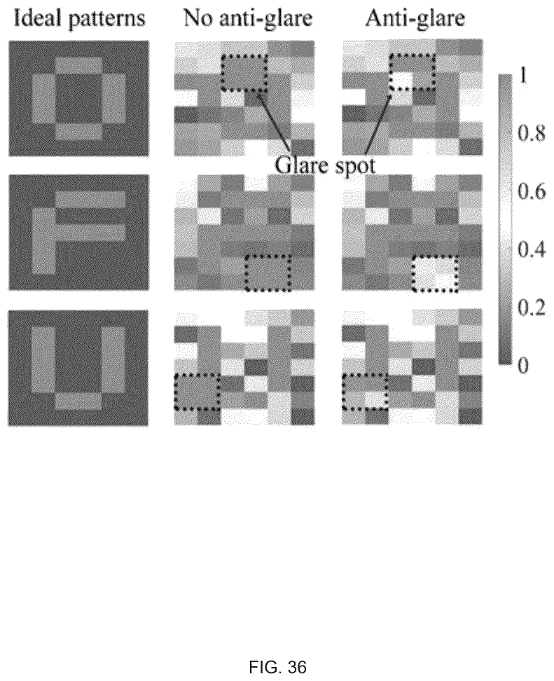

As an example, the anti-glare pattern recognition with OCPM has been presented. A dataset with three letters of “O”, “F”, and “U” with 6×7 pixels was adopted for the training and testing. The scale of each pixel was 0-1. Ideal patterns (no background noise and glare-spot-like noise), no anti-glare patterns, and anti-glare patterns are shown in FIG. 36. The background noise was randomly generated in a margin of 0-0.5. It was assumed that the Brewster angle was reached for the reflected light, indicating the reflected light was linearly polarized. The pixel in the glare spot was considered as “1”, and the glare spot size was 2×2. The suppression degree of glare spots with OCPM was determined by the sensitivity of linearly polarized lights. The dichroic ratio of ˜6.4 under pulsed operation was employed based on experimental results. The noise due to glare spots decreased to the 1/6.4 of original values with the anti-glare processing based on the dichroic ratio. The glare spots were effectively decreased. The patterns were fed into an artificial network for training and recognition.

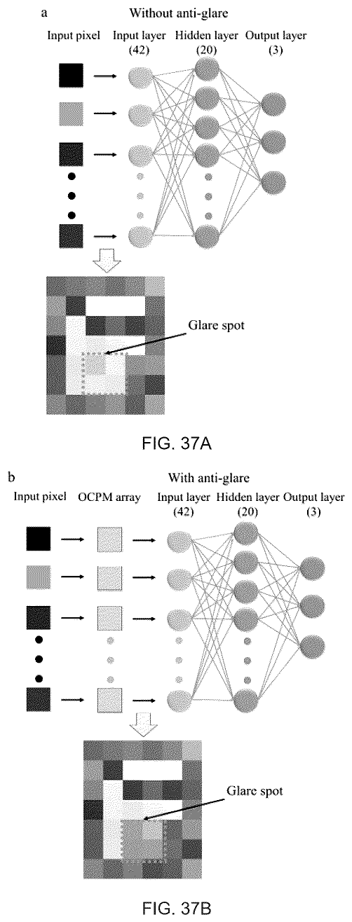

In particular, with reference to FIGS. 37A and 37B, a schematic diagram of artificial neural networks (ANNs) is shown. Three-layered ANN was utilized with an input layer (42 neurons), a hidden layer (20 neurons), and an output layer (3 neurons). The training process was based on the back-propagation (BP) algorithm. The activation function was the Sigmoid function. The input picture without anti-glare exhibited a distorted feature as shown in FIG. 37A. In comparison, the image processed by the OCPM array exhibited a suppressed glare spot as shown in FIG. 37B. The integrated OCPMs perform as a pixel sensor array. The lightness of glare spots can be decreased due to the polarization-sensitivity of OCPM array. The OCPM array was connected to the input layer of ANNs. The pixels of images were exposed to the OCPM array and delivered to the ANN one by one.

Thus, in operation with respect to the system 100, the image may be captured by the image sensor 110 or directly by the polarimetric sensor elements 106 of the polarimetric sensor array 104 and may correspond to at least a portion of the field of view 112. The image may be exposed to the OCPM array 104, and in particular, to the embedded artificial intelligence subsystem, which may be, for example, an embedded artificial neural network (e.g., given by at least one layer) encoded by node weights stored by the sensor elements 106. More particularly, the node weights may be stored by leveraging the atomic structure, large bandgap, and optically programmed storage structure of the ReS₂/GeSe₂ structure. Specifically, as can be seen in FIG. 37B, the encoded ANN of the array 104 filters the input image and produces a modified or filtered output with a reduced glare spot. More particularly, the encoded ANN may filter the input image based on the polarization of the detected incoming light corresponding to the input image, as described above, to filter specific polarizations characteristic of glare spots. The filtered input image results of the embedded ANN of the array 104 is provided to the input layer of the ANN of the AI subsystem 108 (i.e., as the polarization signal) to generate the output and/or for further processing in the machine vision function.

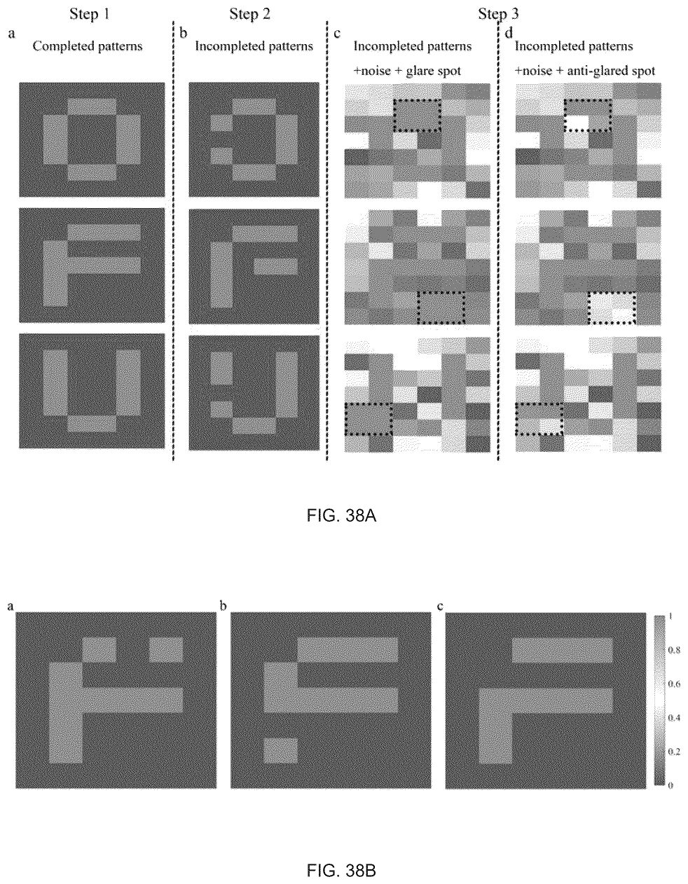

The glare spot from reflected light was assumed as linear polarized light parallel with the objective surface. The OCPM was perpendicular to the polarized reflected light. The brightness of glare spots was reduced to 1/6.4 based on the dichroic ratio of the OCPM. The neuromorphic computing for pattern recognition was based on the code written with MATLAB. The illustration of dataset images for pattern recognition training is shown in FIG. 38A. The pixel for each letter was 6×7 with a scale range of 0-1. Three steps were involved to build up a training dataset. Step 1: Three complete letters of “O”, “F”, and “U” were initial patents as shown in column a. Step 2: Incomplete patterns were generated by randomly missing one pixel of the body pattern for the three letters, as demonstrated in column b. 1000 patterns were generated in total. Three randomly selected incomplete patterns of the letter “F” are presented in FIG. 38B. The missing pixel in the three patterns was different. Step 3: Background noise and glare spots were induced into the patterns as shown in columns c and d of FIG. 38A. The size of glare spots was 2×2 pixel and the position of the glare spots was also arbitrarily located on the pattern body.

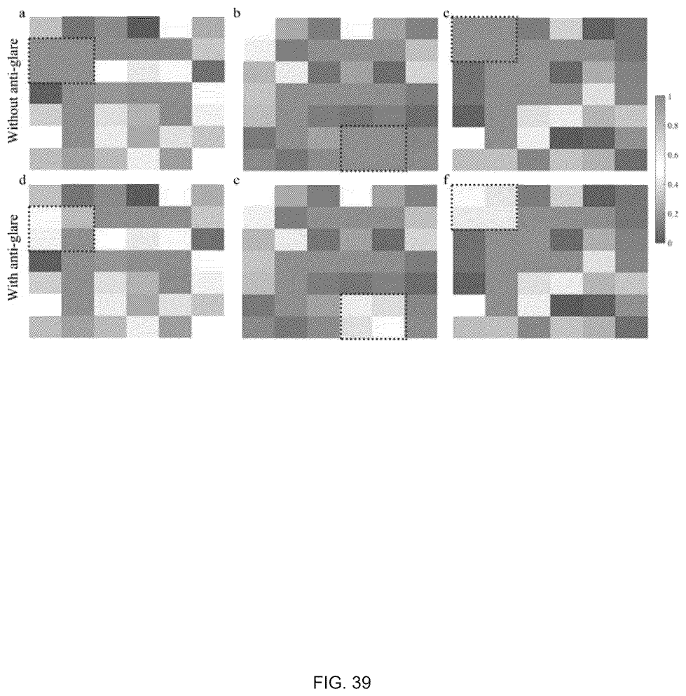

Three example patterns (letter “F”) with and without anti-glare are shown in FIG. 39. It can be found that the positions of glare spots were not stationary. 1000 patterns were generated for the dataset with anti-glare and the dataset without anti-glare. Notably, the only difference between the two datasets was the intensity of glare spots as shown in FIG. 39. This authentically confirms the training efficiency improvement by anti-glare functions.

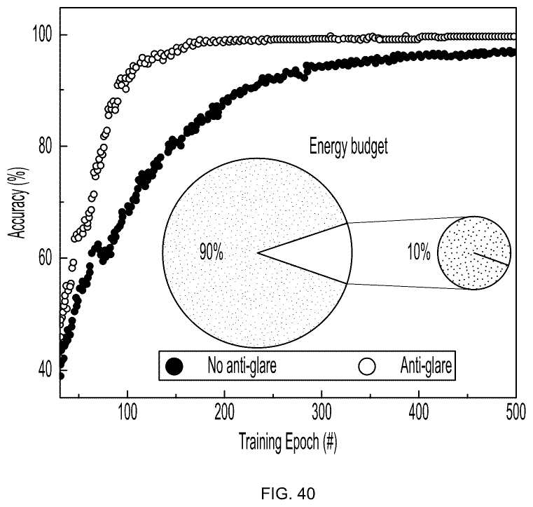

The pattern recognition accuracies with and without OCPM-based anti-glare processing were calculated and depicted in FIG. 40. The anti-glare processing can improve the accuracy compared to the no anti-glare counterparts.

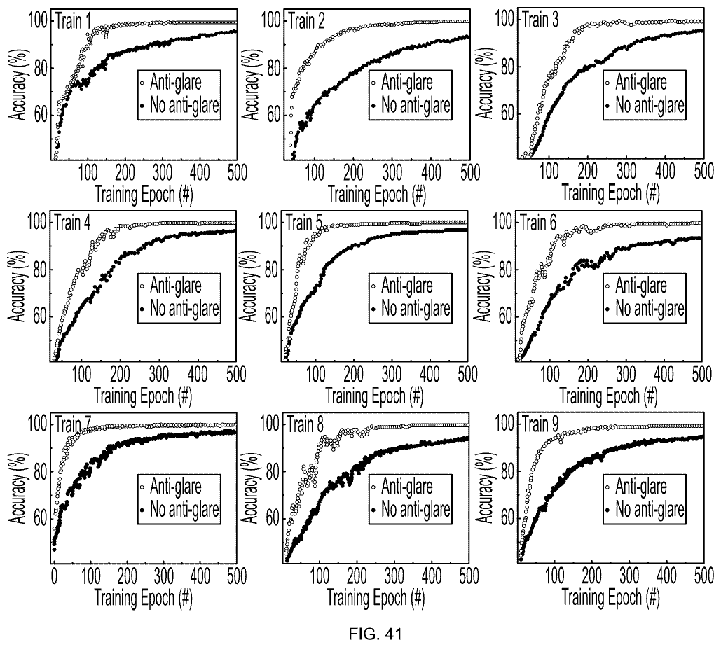

The recognition accuracy plots for 9 running cycles were calculated to implement statistics analysis, as depicted in FIG. 41. The background noise and glare spot position were generated randomly in 9 running cycles. The training processes with anti-glare always overmatched the training accuracy without anti-glare counterparts, though a certain degree of variation was observed between cycle-to-cycle running. This was owing to the stochastic nature of the algorithm and the randomly induced noise. The results confirmed that the anti-glare function can improve pattern recognition efficiency.

To quantitatively evaluate the improvement regarding converge computing speed and energy consumption, the epochs of all simulation running cycles were extracted. Every training epoch should spend the same time and energy for the ANNs with and without anti-glare because they shared the same architecture. Thus, the computing speed and energy consumption are roughly proportional to training epochs, which is the foundation of quantitatively identifying the computing efficiency of the two candidates. The summary of training epochs obtaining different recognition accuracies is given in Table 1.

TABLE 1
The comparison of training efficiency with and
without anti-glare abilities. Rol means ratio of improvement,
RoEC mean the ratio of energy consumption.

| Recognition | Anti-glare | No anti-glare | | |
|---|---|---|---|---|
| accuracy | (Epochs) | (Epochs) | Rol | RoEC |
| 70% | 57 | 99 | 42.9% | 55.8% |
| 80% | 73 | 150 | 51.0% | 47.5% |
| 90% | 99 | 264 | 62.5% | 37.0% |
| 95% | 130 | 451 | 71.1% | 29.4% |
| 97% | 156 | 682 | 77.1% | 23.3% |
| 98% | 245 | 2410 | 89.8% | 11.4% |

The data was extracted from 9 stimulation running cycles. The epochs were the average values of 9 running cycles. In particular, the average values were summarized in Table 1. To get the recognition accuracy of 70%, 57 and 99 training epochs were required for with and without anti-glare functions respectively. 2410 epochs were needed to get 99% accuracy for the humanoid neuromorphic machine vision without anti-glare functions. Remarkably, the anti-glare function can significantly reduce the training epochs to merely 245 using interspecies-chimera machine vision, almost one magnitude of difference. The ratio of improvement (RoI) was as high as nearly 90% which was much higher than previous reported results with image pre-processing abilities.

The rate of improvement (RoI) is defined by the following equation (8):

$$RoI = \frac{Epochs ( without anti glare ) - Epochs ( with anti glare )}{Epochs ( without anti glare )} \times 100 \% \qquad ( 8 )$$

The number of epochs was the average of 9 running simulations. The RoI was 89.8% to realize an accuracy of 99% with the anti-glare function. The training efficiency improvement was higher than the previous reported results, in which optoelectronic resistive random access memory (ORRAM) suppressed the background noise. Furthermore, the energy budget was estimated for the training with and without anti-glare. The ratio of energy consumption (RoEC) is described by the following equation (9):

$$RoEC = \frac{Epochs ( with anti glare )}{Epochs ( without anti glare )} \times 100 \% \qquad ( 9 )$$

Considering the energy consumption for the training process, by utilizing the anti-glare function, the RoEC was merely 11.4% to get a recognition accuracy of 99% compared to that without the anti-glare function. A remarkable improvement in computing speed and energy efficiency was achieved by equipping ANNs with anti-glare abilities. OCPM demonstrates great prospects for advanced neuromorphic vision systems.

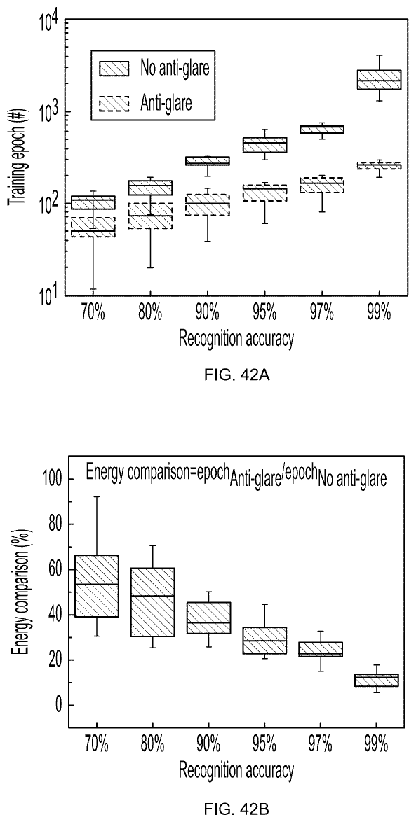

The same conclusion can be obtained that the anti-glare interspecies-chimera machine vision showed superior performances despite minor differences among different running cycles. A statistical comparison of training epochs to get the same recognition accuracies with and without anti-glare abilities is shown in FIG. 42A. More epochs were required to get higher recognition accuracies. Particularly, the gap of epoch numbers enlarged monotonously with the increase of recognition accuracy. 57 and 99 epochs were needed to reach the recognition accuracy of 70%. In comparison, 245 and 2410 epochs were required if an accuracy of 99% was desired, almost a magnitude of difference was discovered. FIG. 42B depicts a statistical comparison of energy consumption to get the same recognition accuracies.

Besides, the training processing is the most energy-intensive step which is determined by neural network size, dataset size, training epochs, etc. As we fixed other variables (network size, dataset size, etc.) during the training process. The training epochs qualitatively reflect the significantly improved energy efficiency. The training energy consumption was reduced to 11.4% aided by the anti-glare abilities, as depicted in the inset of FIG. 40. The OCPM equipped interspecies-chimera machine vision with the anti-glare function, which can effectively improve computing speed with significant lower energy consumption. This technique has a bright future for energy-efficient interspecies-chimera computing systems.

As described herein, an interspecies-chimera machine vision by integrating the polarimetric function of honeybees and the intelligence of human beings. In particular, the device based on a van der Waals heterostructure (ReS2/GeSe2) provides polarization sensitivity, nonvolatility, and positive/negative photoconductance simultaneously. The polarimetric measurement can identify celestial polarizations for real-time navigation. Meanwhile, the anti-glare recognition with polarimetry improved one magnitude of energy efficiency compared to the traditional neuromorphic machine vision counterpart. This technique may have applications in autonomous vehicles, medical diagnoses, intelligent robotics, etc.

The scope of the claims should not be limited by the embodiments set forth in the above examples but should be given the broadest interpretation consistent with the description as a whole.

1. A device comprising:
a polarimetric sensor array comprising an optically controlled polarimetry memtransistor, the polarimetric sensor array configured to:
detect incoming light representing a field of view of the polarimetric sensor array; and
generate a polarization signal representing a polarization of the incoming light; and
an artificial intelligence subsystem interconnected with the polarimetric sensor array, the artificial intelligence subsystem configured to:
process the polarization signal for a machine vision function on the field of view.

2. The device of claim 1, wherein the polarimetric sensor array comprises 2-dimensional stacked layers of rhenium disulfide (ReS₂) and germanium diselenide (GeSe₂).

3. The device of claim 1, wherein the artificial intelligence subsystem is configured to:
receive, as the polarization signal, a measured current from the polarimetric sensor array;
determine, based on the measured current, a solar azimuth angle; and
apply the solar azimuth angle to determine a location of the device given by a latitude and a longitude.

4. The device of claim 3, wherein the artificial intelligence subsystem is configured to:
obtain a plurality of polarization signals, including the polarization signal, each of the plurality polarization signals associated with a respective detection angle of the polarimetric sensor array; and
fit a curve of the solar azimuth angle to the plurality of polarization signals and respective detection angles to determine the solar azimuth angle.

5. The device of claim 4, further comprising a rotatable platform configured to support the polarimetric sensor array to rotate the polarimetric sensor array to the respective detection angles.

6. The device of claim 4, wherein the polarimetric sensor array comprises respective subsets of polarimetric sensor elements oriented at the respective detection angles.

7. The device of claim 1, wherein the polarimetric sensor array includes an embedded artificial neural network configured to:
receive an input image corresponding to at least a portion of the field of view;
filter the input image based on the polarization of the detected incoming light; and
provide the filtered input image to the artificial intelligence subsystem as the polarization signal for the machine vision function.

8. The device of claim 7, wherein the embedded artificial neural network is configured to filter the input image based on the polarization of the detected incoming light to reduce glare in the input image.

9. The device of claim 7, further comprising an image sensor configured to capture the input image.

10. The device of claim 7, wherein the polarimetric sensor array is configured to capture the input image.

11. The device of claim 1, wherein the artificial intelligence subsystem comprises a memory and a processor interconnected with the memory, the processor configured to execute instructions to implement an artificial neural network.

12. A device comprising:
a polarimetric sensor array configured to detect incoming light from a field of view and generate a polarization signal representing a polarization of the incoming light;
an artificial intelligence subsystem connected to the polarimetric sensor array, the artificial intelligence subsystem operable on the polarization signal of the incoming light for a machine vision function on the field of view.

13. A method comprising:
detecting, at a polarimetric sensor array comprising an optically controlled polarimetry memtransistor, incoming light representing a field of view of the polarimetric sensor array;
generating a polarization signal representing a polarization of the incoming light; and
processing the polarization signal for a machine vision function on the field of view.

14. The method of claim 13, further comprising:
measuring, as the polarization signal, a current detected by the polarimetric sensor array;
determining, based on the measured current, a solar azimuth angle; and
applying the solar azimuth angle to determine a location of the device given by a latitude and a longitude.

15. The method of claim 14, further comprising:
obtaining a plurality of polarization signals, including the polarization signal, each of the plurality of polarization signals associated with a respective detection angle of the polarimetric sensor array; and
fit a curve of the solar azimuth angle to the plurality of polarization signals and respective detection angles to determine the solar azimuth angle.

16. The method of claim 15, further comprising rotating the polarimetric sensor array to the respective detection angles to obtain the plurality of polarization signals associated with the respective detection angles.

17. The method of claim 13, further comprising:
receiving, at the polarimetric sensor array, an input image corresponding to at least a portion of the field of view;
filtering the input image based on the polarization of the detected incoming light; and
providing the filtered input image as the polarization signal for the machine vision function.

18. The method of claim 17, comprising filtering the input image based on the polarization of the detected incoming light to reduce glare in the input image.

19. The method of claim 17, further comprising receiving the input image from an image sensor configured to capture the input image.

20. The method of claim 17, comprising capturing the input image by the polarimetric sensor array.
